(19) United States
(12) Patent Application Publication
(10) Pub. No.: US 2019/0034891 A1
(43) Pub. Date: Jan. 31, 2019

(54) AUTOMATED TRANSACTION SYSTEM, METHOD FOR CONTROL THEREOF, AND CARD READER

(71) Applicant: HITACHI-OMRON TERMINAL SOLUTIONS, CORP., Shinagawa-ku, Tokyo (JP)

(72) Inventors: Tomoyoshi ISHIKAWA, Tokyo (JP); Masahiro YOSHII, Tokyo (JP)

(73) Assignee: HITACHI-OMRON TERMINAL SOLUTIONS, CORP., Shinagawa-ku, Tokyo (JP)

(21) Appl. No.: 16/072,619

(22) PCT Filed: Jun. 3, 2016
(86) PCT No.: PCT/JP2016/066630

§ 371 Date: Jul. 25, 2018

(51) Int. Cl. G06Q 20/10; G06Q 40/02; G06Q 20/38

(52) U.S. Cl. CPC G06Q 20/1085; G06Q 20/3829; G06Q 40/02

(57) ABSTRACT

To recommend a highly reliable automated transaction system, method for control thereof, and card reader such that leakage of card information can be sufficiently avoided practically. Provided is an automated transaction system, in which an automated transaction device has disposed thereupon: a card reader which reads first card information which has been recorded on a card medium inserted therein by a user; and a device control unit which generates a request message, transmits said message to a host device, and, on the basis of a response message from the host device, executes a control process for carrying out a transaction. The card reader: stores first card format information in which information which relates to a format of the first card information for each financial institution has been registered; refers to the first card format information so as to acquire prescribed confidential information from the first card information which has been read from the card medium, said prescribed confidential information including a card number; and encrypts the acquired confidential information for transmission to the device control unit. The device control unit generates a request message which includes the encrypted confidential information which has been transmitted from the card reader, and transmits said request message to the host device.

### TECHNICAL FIELD

The present invention relates to an automated transaction system, a method for control thereof, and a card reader. The present invention is suitable for application to an automated transaction system including: an automated teller machine (ATM) that performs deposit and withdrawal transactions based on card information recorded in a credit or cash card and the user's operation; and a core banking host computer that authorizes the deposit and withdrawal transactions and performs other processes, for example.

### BACKGROUND ART

In recent years, along with the rapid development of information societies, the need for management of personal information and confidential information has been increasing in companies, local governments, and the like. In addition, extraction of confidential information by malware and unauthorized transactions has become big issues in the closed networks within ATMs, which were previously not considered problematic.

Confidential information handled by ATMs includes magnetic information recorded in a magnetic tape attached to the back of a card and card information such as a card number and a bank code (Patent Literature 1). If magnetic information is leaked, a counterfeit card can be created for improper use based on the magnetic information. If the card number is leaked together with the expiration date or the like, the leaked information can be improperly used for Internet shopping.

In one of the countermeasures to prevent such information leakage, card information read from a card inserted to an ATM by the user is encrypted by the controller of the ATM to be transmitted to a core banking host computer that authorizes the transaction or performs other processing.

### CITATION LIST

### Patent Literature

Patent Literature 1: JP-A-H05-274331

### SUMMARY OF INVENTION

### Technical Problem

However, even when the ATM controller encrypts card information and transmits the encrypted card information to a core banking host computer as described above, malware infection of components of the ATM, particularly an ATM controller that governs the overall operational control of the ATM and communicates with the core banking host computer, could cause leakage of the card information via the ATM controller.

The present invention has been made in the light of the aforementioned problem, and an object of the present invention is to provide a highly-reliable automated transaction system that is able to prevent leakage of card information sufficiently for practical use, a method for control thereof, and a card reader.

### Solution to Problem

To solve the aforementioned problem, according to the present invention, in an automated transaction system which includes an automated transaction apparatus and a host apparatus and in which the automated transaction apparatus transmits to the host apparatus, a request message for a transaction corresponding to a user's operation for the automated transaction apparatus and performs the transaction based on a response message from the host apparatus corresponding to the request message, the automated transaction apparatus includes: a card reader that reads first card information recorded in the card medium inserted by the user: and an apparatus controller that generates the request message, transmits the generated request message to the host apparatus, and executes a control process to perform the transaction based on the response message from the host apparatus. The card reader holds first card format information including information that is related to the format of the first card information and is specific to each financial institution. With reference to the first card format information, the card reader acquires predetermined confidential information including the card number from the first card information read from the card medium. The card reader encrypts the acquired confidential information and transmits the encrypted confidential information to the apparatus controller. The apparatus controller generates the request message including the encrypted confidential information transmitted from the card reader and transmits the generated request message to the host apparatus.

Moreover, according to the present invention, in a method for control of an automated transaction system which includes an automated transaction apparatus and a host apparatus and in which the automated transaction apparatus transmits to the host apparatus, a request message for a transaction corresponding to a user's operation for the automated transaction apparatus and performs the transaction based on a response message from the host apparatus corresponding to the request message, the automated transaction apparatus includes: a card reader that reads first card information recorded in the card medium inserted by the user; and an apparatus controller that generates the request message, transmits the generated request message to the host apparatus, and executes a control process to perform the transaction based on the response message from the host apparatus. The card reader holds first card format information in which information that is related to the format of the first card information is registered and which is specific to each financial institution. The control method includes: a first step of, by referring to the first card format information, the card reader acquiring predetermined confidential information including the card number from the first card information read from the card medium; a second step of the card reader encrypting the acquired confidential information and transmitting the encrypted confidential information to the apparatus controller; and a third step of the apparatus controller generating the request message including the encrypted confidential information transmitted from the card reader and transmitting the generated request message to the host apparatus.

Furthermore, according to the present invention, a card reader is provided for an automated transaction apparatus, that transmits a request message for a transaction corresponding to a user's operation and performs the transaction based on a response message from the host apparatus corresponding to the request message, and reads card information recorded in a card medium inserted into the automated transaction apparatus by the user. The card reader includes: a card transporting and reading section which transports the card medium inserted in the automated transaction apparatus and reads the card information from the card medium; and a card reader cryptographic processor which encrypts the card information read from the card medium by the card transporting and reading section. The automated transaction apparatus includes: an apparatus controller that generates the request message, transmits the generated request message to the host apparatus, and executes a control process to perform the transaction based on the response message from the host apparatus. The card reader cryptographic processor holds first card format information in which information that is related to the format of the first card information is registered and which is specific to each financial institution; by referring to the first card format information, acquires predetermined confidential information including the card number from the first card information read from the card medium: encrypts the acquired confidential information; and transmits the encrypted confidential information to the apparatus controller.

According to the automated transaction system, the control method therefor, and the card reader of the present invention, the confidential information is encrypted. Even if the ATM controller is infected with malware and leaks the first information, it is therefore possible to prevent leakage of the card number necessary for creation of a counterfeit card or improper use for Internet shopping.

### Advantageous Effects of Invention

According to the present invention, it is possible to implement a highly-reliable automated transaction system which is able to prevent leakage of card information sufficiently for practical use, a method for control thereof, and a card reader.

### BRIEF DESCRIPTION OF DRAWINGS

FIG. 1 is a block diagram illustrating the entire configuration of an automated transaction system according to a first embodiment;

FIG. 2 is a block diagram illustrating the configuration of an ATM controller;

FIG. 3A is a block diagram illustrating the configuration of a card reader;

FIG. 3B is a block diagram illustrating the configuration of a card reader controller;

FIG. 3C is a block diagram illustrating the configuration of a card reader cryptographic processor;

FIG. 4A is a block diagram illustrating the configuration of an encryption keypad section;

FIG. 4B is a block diagram illustrating the configuration of the encryption keypad section;

FIG. 5 is a block diagram illustrating the configuration of an IC card.

FIG. 6 is a block diagram illustrating the configuration of a core banking host computer;

FIG. 7A is a conceptual diagram illustrating the configuration of an FIT;

FIG. 7B is a conceptual diagram illustrating the configuration of FIT confidential information card format information;

FIG. 8 is a block diagram illustrating the configuration of a certificate authority;

FIG. 9 is a flowchart illustrating the flow of initial setting of a root key pair and a CR key pair;

FIG. 10 is a flowchart illustrating the flow of initial setting of an EPP key pair;

FIG. 11 is a flowchart illustrating the flow of initial setting of host keys;

FIG. 12 is a flowchart illustrating the flow of master key exchange between the card reader and an encryption keypad;

FIG. 13 is a flowchart illustrating the flow of master key exchange between the card reader and encryption keypad;

FIG. 14 is a flowchart illustrating the flow of master key exchange between the card reader and core banking host computer;

FIG. 15 is a flowchart illustrating the flow of master key exchange between the card reader and core banking host computer;

FIG. 16 is a flowchart illustrating the flow of session key exchange between the card reader and encryption keypad;

FIG. 17 is a flowchart illustrating the flow of session key exchange between the card reader and core banking host computer;

FIG. 18 is a flowchart illustrating the flow of an FIT update process in IC card transaction processing;

FIG. 19 is a flowchart illustrating the flow of a card reading process to read magnetic information from the IC card in the IC card transaction processing;

FIG. 20 is a flowchart illustrating the flow of an FIT check process in the IC card transaction processing;

FIG. 21 is a flowchart illustrating the flow of a card reading process to read IC information from the IC card in the IC card transaction processing;

FIG. 22 is a flowchart illustrating the flow of a process related to PIN entry in the IC card transaction processing;

FIG. 23 is a flowchart illustrating the flow of a process related to entry of a transaction amount in the IC card transaction processing;

FIG. 24 is a flowchart illustrating the flow of a process to acquire card authentication data in the IC card transaction processing;

FIG. 25 is a flowchart illustrating the flow of a process in the IC card transaction processing through which an ATM controller transmits a transaction request to the core banking host computer;

FIG. 26 is a flowchart illustrating the flow of a process in the IC card transaction processing through which the ATM controller acquires a transaction response message from the core banking host computer;

FIG. 27 is a flowchart illustrating the flow of issuer authentication and withdrawal processes in the IC card transaction processing;

FIG. 28 is a block diagram illustrating the entire configuration of an automated transaction system according to a second embodiment;

FIG. 29 is a flowchart illustrating the flow of an FIT update process in the automated transaction system according to the second embodiment;

FIG. 30 is a flowchart illustrating the flow of an FIT check process in the automated transaction system according to the second embodiment;

FIG. 31 is a block diagram illustrating the entire configuration of an automated transaction system according to a third embodiment;

FIG. 32 is a block diagram illustrating the configuration of a card reader cryptographic processor of the automated transaction system according to the third embodiment;

FIG. 33 is a block diagram illustrating the configuration of a core banking host computer of the automated transaction system according to the third embodiment;

FIG. 34 is a flowchart illustrating the flow of initial setting of a root key pair and a CR key pair in the automated transaction system according to the third embodiment;

FIG. 35 is a flowchart illustrating the flow of initial setting of a host key in the automated transaction system according to the third embodiment;

FIG. 36 is a flowchart illustrating the flow of master key exchange between a card reader and a core banking host computer in the automated transaction system according to the third embodiment; and

FIG. 37 is a flowchart illustrating the flow of master key exchange between the card reader and core banking host computer in the automated transaction system according to the third embodiment.

### DESCRIPTION OF EMBODIMENTS

Hereinafter, embodiments of the present invention are described in detail with reference to the drawings.

### (1) First Embodiment

### (1-1) Configuration of Automated Transaction System of First Embodiment

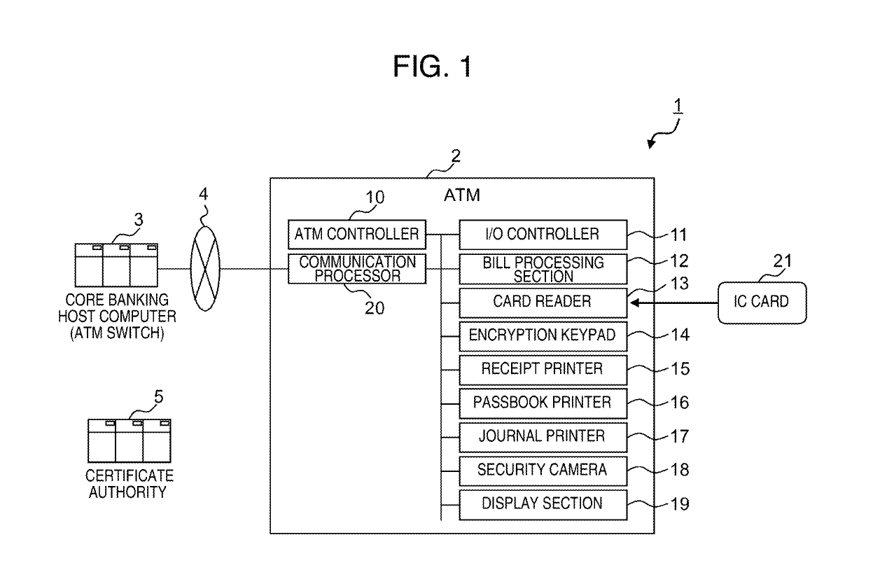

In FIG. 1, reference sign 1 throughout indicates an automated transaction system according to the first embodiment. The automated transaction system 1 includes one or plural ATMs 2 and a core banking host computer 3 which are connected through a wide area network 4 such as a local area network (LAN) or a wide area network (WAN). The automated transaction system 1 further includes a certificate authority 5 separately from the ATMs 2 and the core banking host computer 3.

The ATM 2 is an automated transaction apparatus which performs transactions, including deposits and withdrawals of cash, in response to users' operations. As illustrated in FIG. 1, the ATM 2 includes an ATM controller 10, an I/O controller 11, a bill processing section 12, a card reader 13, an encryption keypad 14, a receipt printer 15, a passbook printer 16, a journal printer 17, a security camera 18, a display section 19, and a communication processor 20. The ATM controller 10 governs the overall operational control of the ATM 2. The I/O controller 11 controls various types of indicators of the ATM 2, detects the opening of covers, and performs other processing. The bill processing section 12 counts the number of bills inserted into a cash slot provided in the front of the ATM 2 and transports and stores the bills in a vault or extracts bills to be dispensed, from the vault and transports the extracted bills to the cash slot. The card reader 13 reads information recorded in a card medium, such as a cash card, necessary for a transaction at the ATM 2. The encryption keypad 14 includes a numeric keypad allowing entry of a transaction amount, a personal identification number, and the like and has a function to encrypt the entered information such as the personal identification number. The receipt printer 15 is composed of a printer for transaction statements. The passbook printer 16 is composed of a printer for a passbook. The journal printer 17 records a log of ATM transactions. The security camera 18 takes face photos of ATM users. The display section 19 displays information concerning transactions including deposit and withdrawal transactions. The communication processor 20 communicates with the core banking host computer 3. The display section 19 may be a display operation section that accepts users' operations.

The ATM 2 may include a processing section (not illustrated) that handles deposited coins and coins to be dispensed. In the example described in the first embodiment, the card medium is an integrated circuit (IC) card 21.

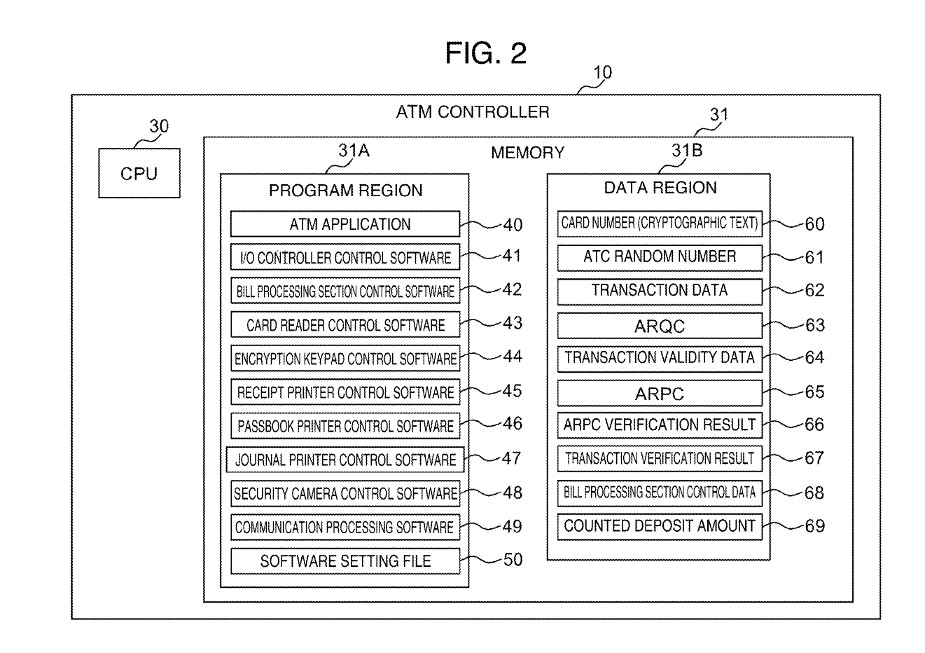

FIG. 2 illustrates a schematic configuration of the ATM controller 10. As illustrated in FIG. 2, the ATM controller 10 includes a microcomputer structure including information processing resources, including a central processing unit (CPU) 30 and a memory 31. The CPU 30 is a processor that governs the overall operational control of the ATM controller 10. The memory 31 is composed of a semiconductor memory, for example, and stores programs and data.

The storage area of the memory 31 of the ATM controller 10 is divided into a program region 31A and a data region 31B for management. The program region 31A stores an ATM application 40 controlling entire transactions of the ATM 2, software to control the I/O (Input/Output) controller 11, bill processing section 12, card reader 13, encryption keypad 14, receipt printer 15, passbook printer 16, journal printer 17, security camera 18, display section 19, and communication processor 20, and a software setting file 50 as a setting file for software environments and the like. The above software includes I/O controller control software 41, bill processing section control software 42, card reader control software 43, encryption keypad control software 44, receipt printer control software 45, passbook printer control software 46, journal printer control software 47, security camera control software 48, and communication processor software 49.

The data region 31B stores data necessary for deposit and withdrawal transactions at the ATM 2. For example, the data region 31B stores: a card number 60; an ATM controller (ATC) random number 61 generated at each transaction to enhance the security of transaction messages exchanged with the core banking host computer 3 (FIG. 1); transaction data 62 as transaction message data including magnetic information; an authentication request cryptogram (ARQC) 63; transaction validity data 64 which is data resulting from determining whether to effect the transaction; an authentication response cryptogram (ARPC) 65, an ARPC verification result 66 as a verification result of validity of the ARPC, a transaction verification result 67 as a verification result of transaction validity by the IC card 21 (FIG. 1); bill processing section control data 68 as command data transmitted to the bill processing section 12 (FIG. 1); a deposit counted amount 69 which is the total counted deposit amount corresponding to the number of bills inserted into the ATM 2 (FIG. 1) at a deposit transaction and counted by the bill processing section 12 (FIG. 1); and the like.

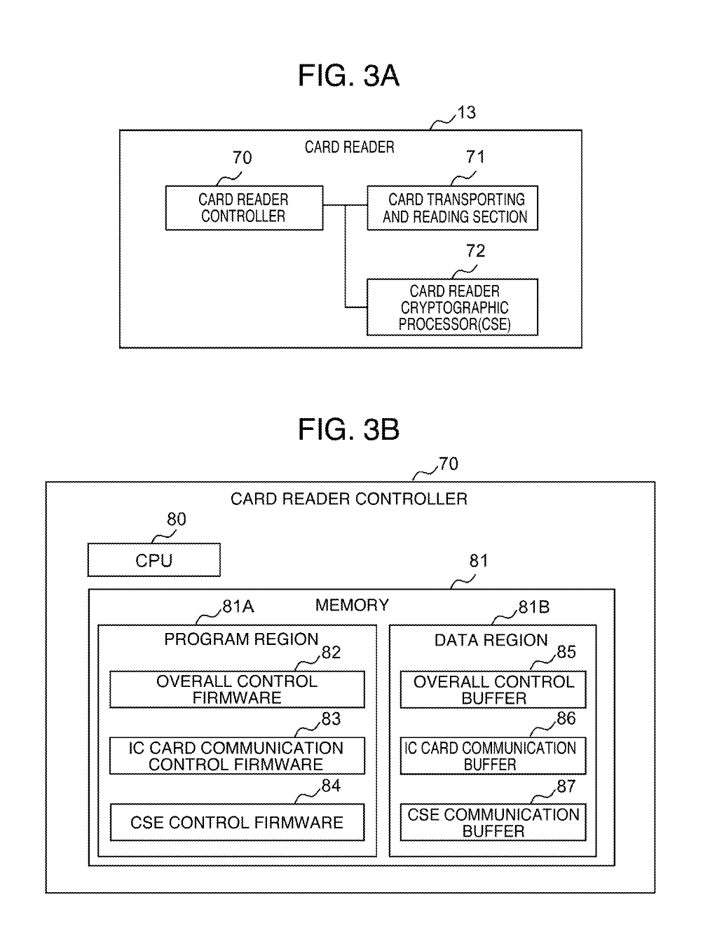

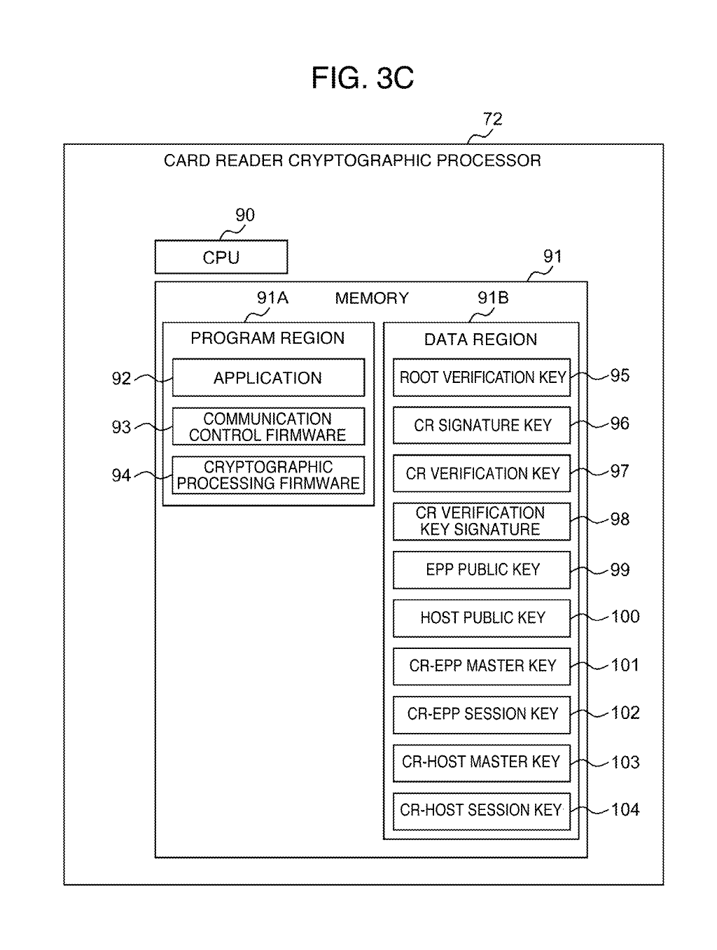

FIG. 3A illustrates a schematic configuration of the card reader 13 (FIG. 1). As illustrated in FIG. 3A, the card reader 13 includes a card reader controller 70, a card transporting and reading section 71, and a card reader cryptographic processor 72. The card reader controller 70 is a hardware unit having a function to control the card transporting and reading section 71 and the card reader cryptographic processor 72 and a function to exchange data with the card transporting and reading section 71 and the card reader cryptographic processor 72. The card transporting and reading section 71 is a hardware unit having a function to transport the IC card 21 between the card slot (not illustrated) of the ATM 2 and the reading section of the card reader 13 within the ATM 2 and a function to input and output data into and from the IC card 21 through a contact of the IC card 21. The card reader cryptographic processor 72 is a hardware unit having a function to perform cryptographic processing, such as encryption of the card information, within the card reader 13. The card reader cryptographic processor 72 may be a detachable cryptographic processing device, such as a secure access module (SAM).

As illustrated in FIG. 3B, the card reader controller 70 includes information processing resources, including a CPU 80 that governs the overall operational control of the card reader controller 70 and a memory 81 composed of a semiconductor memory, for example. The storage region of the memory 81 of the card reader controller 70 is divided into a program region 81A and a data region 81B for management. The program region 81A stores overall control firmware 82, IC card communication control firmware 83, and card reader secure element (CSE) control firmware 84. The data region 81B includes an overall control buffer 85, an IC card communication buffer 86, and a CSE communication buffer 87.

The overall control firmware 82 is software having a function to control communication with the ATM controller 10 and a function to control transportation by the card transporting and reading section 71 (FIG. 3A). The IC card communication control firmware 83 is software having a function to control inputs and outputs of data from and to the IC card 21. The CSE control firmware 84 is software that controls the card reader cryptographic processor 72 (FIG. 3A) and controls communication with the card reader cryptographic processor 72.

The overall control buffer 85 is a data area used for overall control and includes a buffer for communication with the ATM controller 10. The IC card communication buffer 86 and CSE communication buffer 87 are buffers for controlling communication with the IC card 21 and the card reader cryptographic processor 72, respectively.

As illustrated in FIG. 3C, the card reader cryptographic processor 72 includes information processing resources, including a CPU 90 which is a processor that governs the overall operational control of the card reader cryptographic processor 72 and a memory 91 composed of a semiconductor memory or the like, for example.

The storage region of the memory 91 of the card reader cryptographic processor 72 is divided into a program region 91A and a data region 91B for management in a similar manner to the card reader controller 70 (FIG. 3B).

The memory 91A stores an application 92, communication control firmware 93, and cryptographic processing firmware 94. The application 92 is software having a function to control the entire card reader cryptographic processor 72. The communication control firmware 93 is software having a function to control communication with the card reader controller 70. The cryptographic processing firmware 94 is software having a function to perform electronic signature-related processing, encryption, and the like.

The data region 91B properly stores a root verification key 95, a CR signature key 96, a CR verification key 97, a CR verification key signature 98, an EPP public key 99, a host public key 100, a CR-EPP master key 101, a CR-EPP session key 102, a CR-host master key 103, a CR-host session key 104, and the like during each process of various types of processing described later.

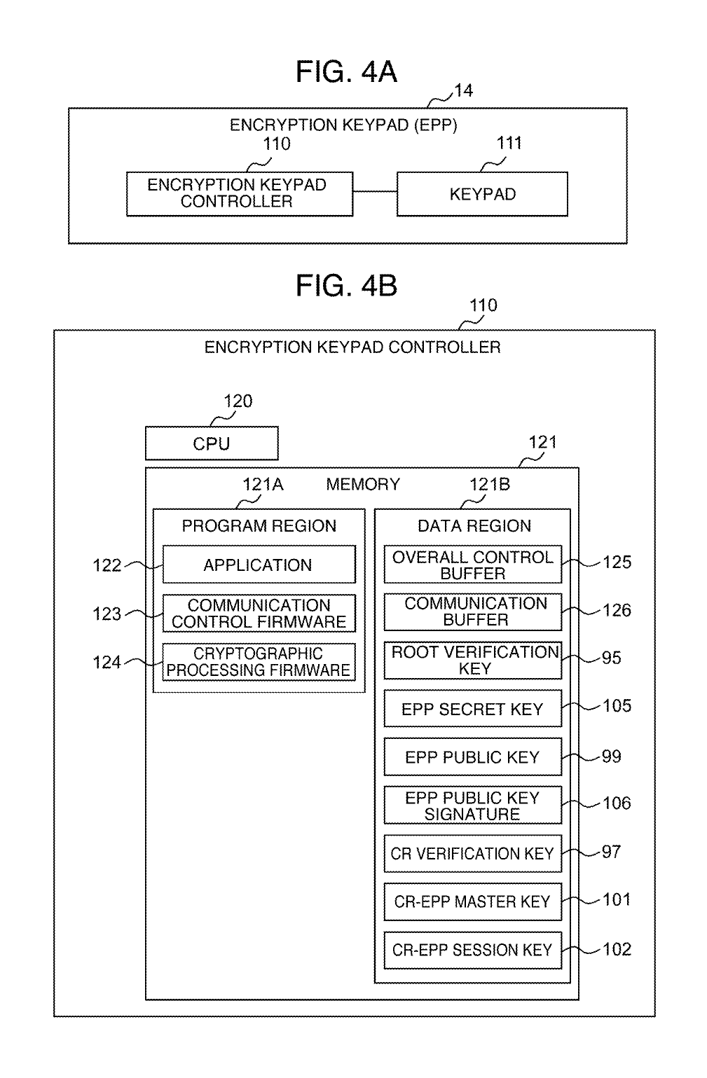

The encryption keypad (EPP) 14 includes an encryption keypad controller 110, a keypad 111, and the like as illustrated in FIG. 4A. The encryption keypad controller 110 is a hardware unit having a function to control the keypad 111 and a function to exchange data between the encryption keypad controller 110 and the keypad 111. The keypad 111 is a hardware unit which is provided on a housing of the ATM 2 so as to accept customers' operations. The keypad 111 accepts entry of a personal identification number, an amount of money, and the like.

As illustrated in FIG. 4B, the encryption keypad controller 110 includes information processing resources, including a CPU 120 which is a processor that governs the overall operational control of the encryption keypad controller 110 and a memory 121 composed of a semiconductor memory or the like, for example.

The storage region of the memory 121 of the encryption keypad controller 110 is divided into a program region 121A and a data region 121B for management.

The program region 121A stores an application 122, communication control firmware 123, and cryptographic processing firmware 124. The application 122 is software having a function to control the entire encryption keypad controller 110. The communication control firmware 123 is software having a function to control communication with the ATM controller 10 and card reader 13. The cryptographic processing firmware 124 is software having a function to perform electronic signature-related processing, encryption, and the like.

The data region 121B includes an overall control buffer 125 and a communication buffer 126. The data region 121B properly stores the root verification key 95, an EPP secret key 105, the EPP public key 99, an EPP public key signature 106, the CR verification key 97, the CR-EPP master key 101, the CR-EPP session key 102, and the like during each process of various types of processing described later.

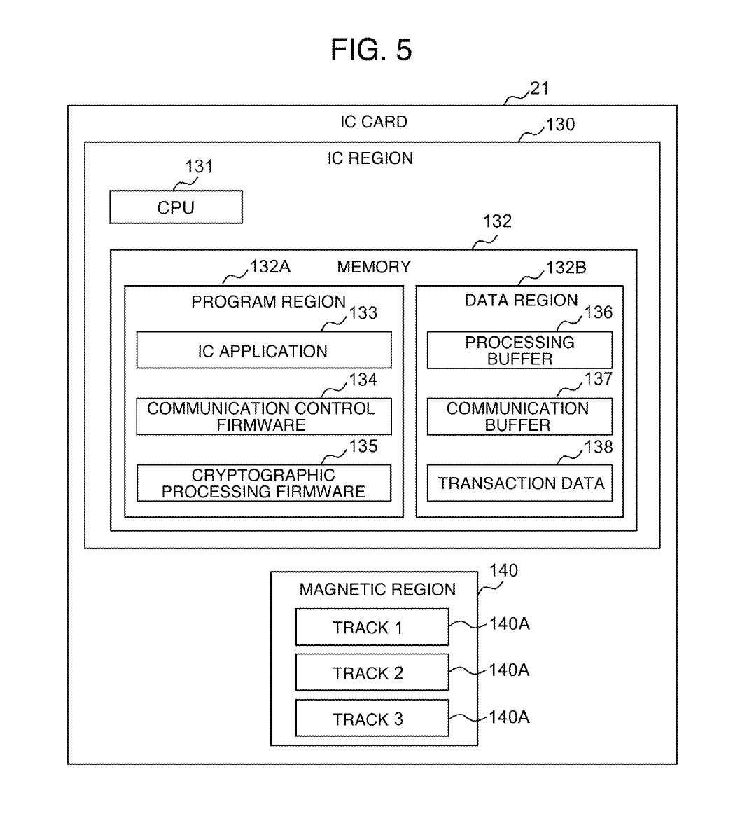

FIG. 5 illustrates a schematic configuration of the IC card 21. The IC card 21 includes: an IC region 130 composed of an IC chip mounted on the IC card 21; and a magnetic region 140 composed of a magnetic tape attached to the back of the IC card 21.

The IC region 130 includes information processing resources, including a CPU 131 and a memory 132. The CPU 131 is a processor that governs the operational control of the IC region 130 of the IC card 21. The memory 132 is composed of a semiconductor memory, for example.

The storage region of the memory 132 of the IC region 130 is divided into a program region 132A and a data region 132B for management. The program region 132A stores an IC application 133 that controls processing in the IC region 130, communication control firmware 134, cryptographic processing firmware 135, and the like.

The IC application 133 is software that controls the entire IC card 21. The communication control firmware 134 is software having a function to control data communication with the card reader 13 (FIG. 1). The cryptographic processing firmware 135 is software having a cryptographic processing function to generate a message authentication code and verify a message authentication code transmitted from the core banking host computer 3.

The data region 132B stores data necessary for processing in the IC region 130. To be specific, the data region 132B includes a processing buffer 136 and a communication buffer 137 necessary for control in the IC region 130 and stores transaction data 138 necessary for transactions using the IC card 21. The transaction data 138 includes a card number (hereinafter, referred to as a primary account number (PAN)), information having the substantially same contents as later-described magnetic information stored in the magnetic region 140, discretionary information, and the like. The discretionary information is information that the financial institution that has issued the IC card 21 can freely store.

In the magnetic information 140, each track (tracks 1 to 3 in FIG. 5) 140A of the magnetic tape stores necessary magnetic information. The magnetic information includes: an identifier (a financial institution ID) which is given to the financial institution having issued the IC card 21 and is specific to the same financial institution; the maximum number of digits (maximum PIN length) of the personal identification number (hereinafter, referred to as PIN) determined by the financial institution; the number of digits of the PAN (PAN length) of the financial institution, a code (language code) indicating the language associated with the IC 21.

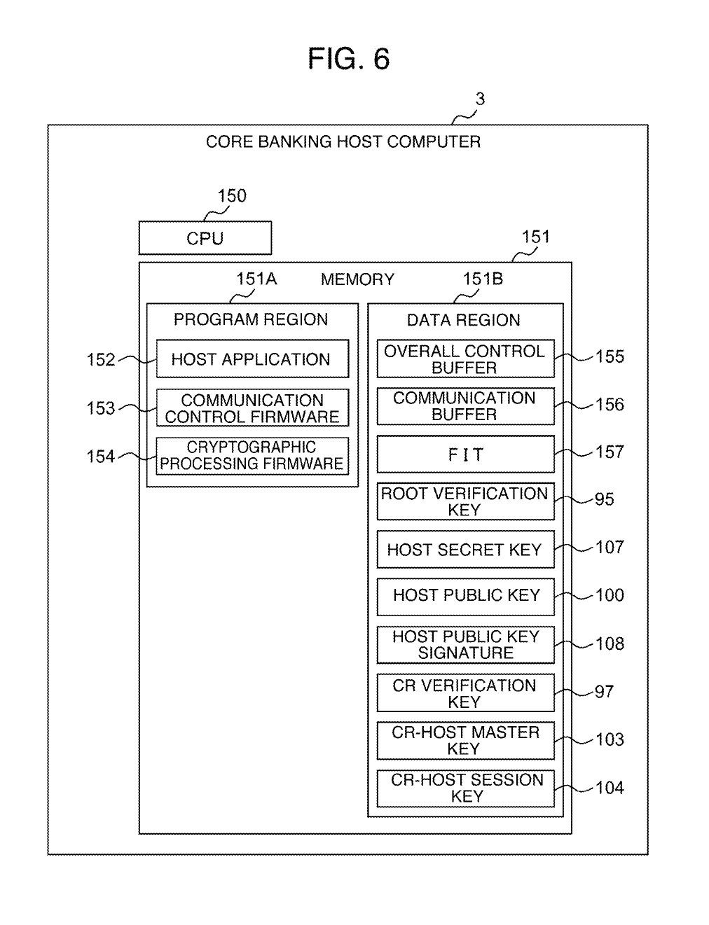

FIG. 6 illustrates a schematic configuration of the core banking host computer 3. The core banking host computer 3 is a computer apparatus that stores and manages information concerning the user's account and balance of the ATMs 2. The core banking host computer 3 includes information processing resources including a CPU 150 and a memory 151, as illustrated in FIG. 6. The CPU 150 is a processor that governs the overall operational control of the core banking host computer 3. The memory 151 is composed of a semiconductor memory, for example.

The storage region of the memory 151 of the core banking host computer 3 is divided into a program region 151A and a data region 151B for management. The program region 151A stores a host application 152 that controls the overall processing of the core banking host computer 3, communication control software 153, cryptographic processing software 154, and the like.

The host application 152 is software that controls the entire core banking host computer 3. The communication control software 153 is software having a function to control data communication between the core banking host computer 3 and each ATM 2. The cryptographic processing software 154 is software having a cryptographic processing function to verify a message authentication code transmitted from each ATM 2 and generate a new message authentication code.

The memory 151B stores data necessary for processing in the core banking host computer 3. To be specific, the data region 151B includes an overall control buffer 155 necessary for the overall control of the core banking host computer 3 and a communication buffer 156. The memory 151B properly stores the root verification key 95, a host secret key 107, the host public key 100, a host public key signature 108, the CR verification key 97, the CR-host master key 103, the CR-host session key 104, and the like during each process of various types of processing described later.

The memory 151B of the memory 151 of the core banking host computer 3 further stores a financial institution table (FIT) 157 necessary for transactions using the IC card 21.

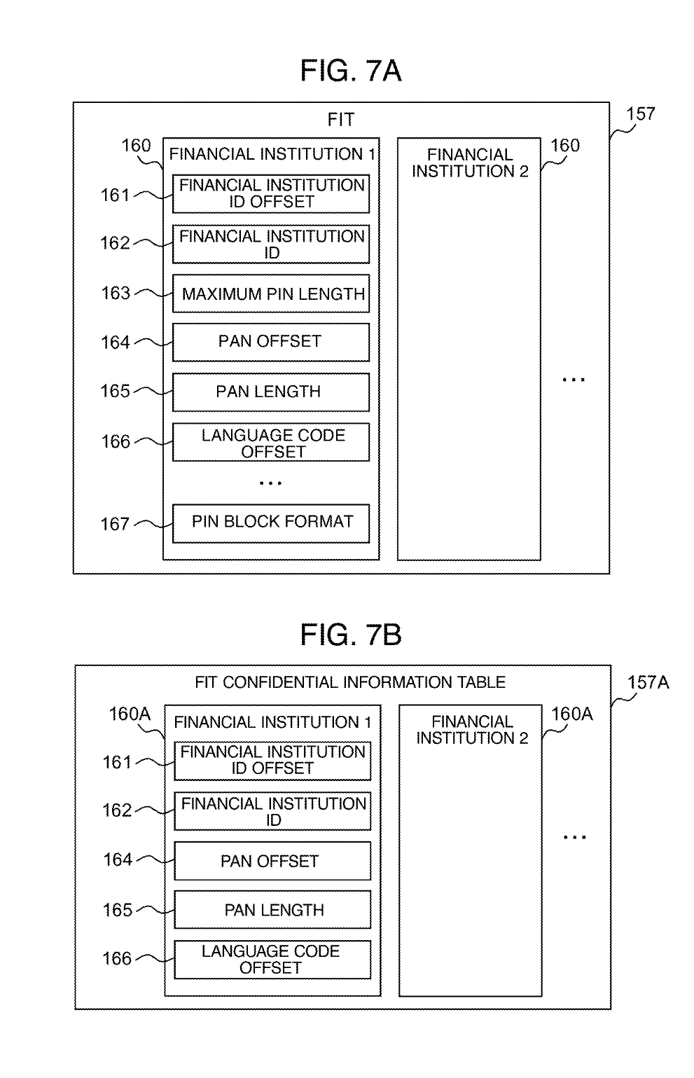

The FIT 157 is a table storing various types of information specific to each financial institution. As illustrated in FIG. 7A, the FIT 157 stores information 161 to 167, including a set of a financial institution ID offset, a financial institution ID, a maximum PIN length, a PAN offset, a PAN length, a language code offset, and a PIN block format, as information (hereinafter, referred to as record information) of a record 160 for each financial institution.

The financial institution ID is an identifier which is given to the corresponding financial institution and is specific to the same financial institution as described above. The financial institution ID offset refers to an amount of offset of the stored financial institution ID from the top of the storage region of the magnetic tape attached to the back of the IC card 21 that the same financial institution has issued. The maximum PIN length refers to the maximum length of the personal identification number (PIN) determined by the same financial institution as described above.

The PAN offset refers to an amount of offset of the stored PAN (card number) from the top of the storage region of the magnetic tape of the IC card 21 that the same financial institution has issued. The PAN length refers to the length of the card number of the financial institution.

The language code offset refers to an amount of offset of the stored language code from the top of the storage region of the magnetic tape of the IC card 21 that the same financial institution has issued. The PIN block format refers to a format (an encryption format) used to encrypt within the encryption keypad 14, the PIN entered by the user.

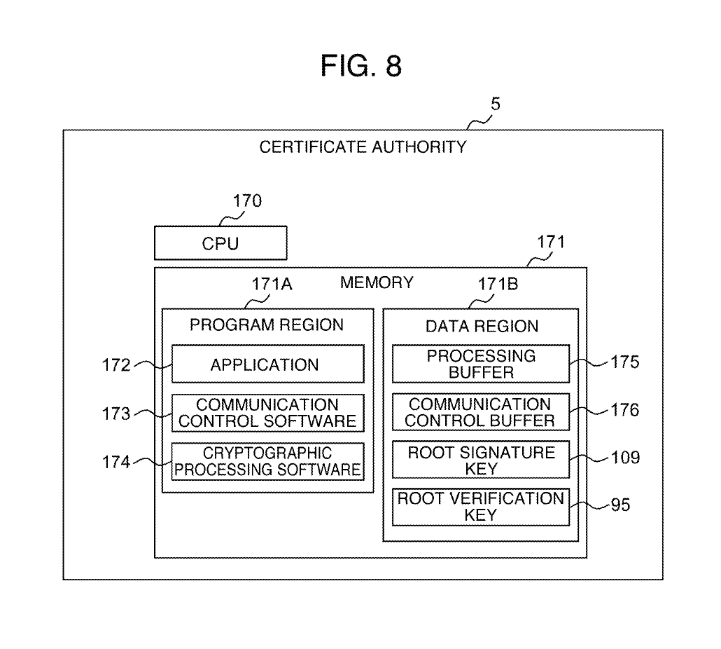

FIG. 8 illustrates a schematic configuration of the certificate authority 5. The certificate authority 5 is a computer apparatus that gives a signature to a necessary public key. The certificate authority 5 includes information processing resources, including a CPU 170 and a memory 171. The CPU 170 is a processor that governs the overall operational control of the certificate authority 5. The memory 171 is composed of a semiconductor memory, for example.

The storage region of the memory 171 of the certificate authority 5 is divided into a program region 171A and a data region 171B for management. The memory 171A stores: an application 172 that controls the overall processing of the certificate authority 5; communication control software 173 that outputs a verification key and performs other processing; and cryptographic processing software 174 having a function to execute various types of processing concerning encryption.

The data region 171B stores data necessary for processing in the certificate authority 5. To be specific, the data region 171B includes: a processing buffer 175 necessary for overall control of the certificate authority 5; and a communication control buffer 176 used to control communication. The data region 171B properly stores a root signature key 109, the root verification key 95, and the like during each process of various types of processing described later.

### (1-2) Processing Flow in Automated Transaction System

Next, a description is given of the flow of each process executed in the automated transaction system 1 of the first embodiment. In the following description, subjects that execute various types of processing are the ATM controller 10 (FIG. 2), the card reader controller 70 (FIG. 3B), the card reader cryptographic processor 72 (FIG. 3C), the encryption keypad controller 110 (FIG. 4B), the IC card 21 (FIG. 5), the core banking host computer 3 (FIG. 6), and the certificate authority 5 (FIG. 8). Each process is executed based on the corresponding program or software by the CPU 30, 80, 90, 120, 131, 150, or 170 (FIGS. 2, 3B, 3C, 4B, 5, 6, and 8) in the ATM controller 10, the card reader controller 70, the card reader cryptographic processor 72, the encryption keypad controller 110, the IC card 21, the core banking host computer 3, or the certificate authority 5.

### (1-2-1) Flow of Key Setting

First, a description is given of the flow of setting of cryptographic keys necessary for implementation of a secure transaction in the automated transaction system 1. The key setting is performed before the ATM 2 becomes available for users.

### (1-2-1-1) Flow of Initial Setting of Root Key Pair and Card Reader Key Pair

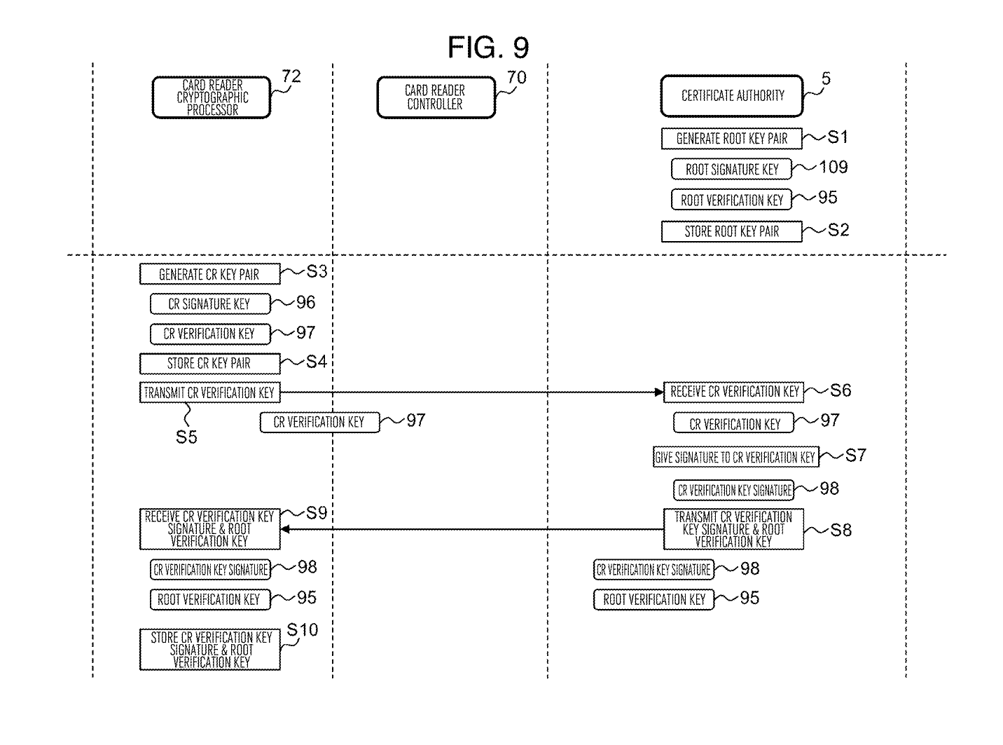

FIG. 9 illustrates the flow of the procedure to set initial keys (a root key pair and a card reader key pair) which is executed for the card reader 13 (FIG. 3A) of the ATM 2 and the certificate authority 5 (FIG. 8). In the following description, the card reader is properly referred to as a CR.

For setting the initial keys, first, an asymmetric root key pair (the root signature key 109 and the root verification key 95) is generated by an organization (mainly assumed to be an ATM vendor) responsible for secure transactions in the automated transaction system 1, in the certificate authority 5 having a secure environment (S1). The certificate authority 5 stores the generated root signature key 109 and root verification key 95 in the data region 171B of the memory 171 (FIG. 8) of the certificate authority 5 (S2).

In the ATM 2, the card reader cryptographic processor 72 of the card reader 13 (FIG. 3A) generates a CR key pair which is asymmetric cryptographic keys (the CR signature key 96 and the CR verification key 97) (S3). The card reader cryptographic processor 72 then stores the generated CR signature key 96 and CR verification key 97 in the data region 91B (FIG. 3C) of the memory 91 (FIG. 3C) (S4). Thereafter, the card reader cryptographic processor 72 transmits the CR verification key 97 to the certificate authority 5 in order to give an electronic signature the CR verification key 97 using the root signature key 109 (S5).

Upon receiving the CR verification key 97 (S6), the certificate authority 5 uses the root signature key 109 generated in the step S1 to give an electronic signature (the CR verification key signature 98) to the CR verification key 97 (S7). The certificate authority 5 transmits the given CR verification key signature 98 and the root verification key 95 generated in the step S1 to the card reader cryptographic processor 72 (S8).

Upon receiving the CR verification key signature 98 and the root verification key 95 (S9), the card reader cryptographic processor 72 stores the received CR verification key signature 98 and root verification key 95 in the data region 91B (FIG. 3C) of the memory 91 (FIG. 3C) (S10).

### (1-2-1-2) Flow of Initial Setting of Encryption Keypad Key Pair

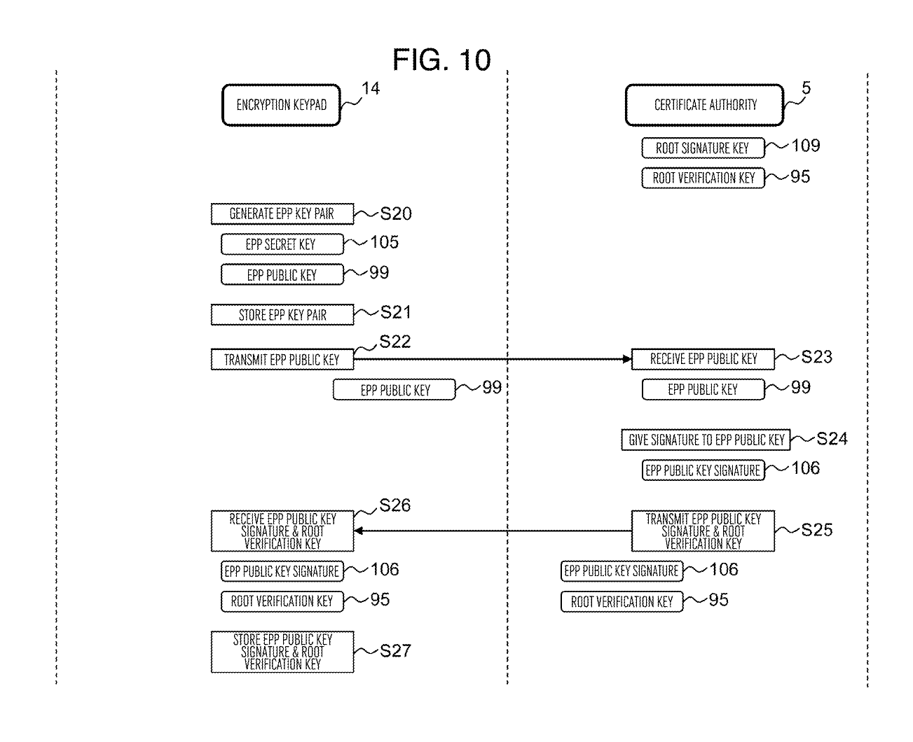

FIG. 10 illustrates the flow of setting of an encryption keypad key pair executed by the encryption keypad 14 and certificate authority 5. In the following description, the encryption keypad is properly referred to as an EPP.

After the certificate authority 5 generates the root signature key 109 and root verification key 95 described for FIG. 9, the encryption keypad 14 generates an asymmetric EPP key pair (the EPP secret key 105 and EPP public key 99) (S20).

The encryption keypad 14 (to be precise, the encryption keypad controller 110, the same applies to the following description) stores the generated EPP secret key 105 and EPP public key 99 in the data region 121B (FIG. 4B) of the memory 121 (FIG. 4B) of the encryption keypad controller 110 (S21). The encryption keypad 14 transmits the generated EPP public key 99 to the certificate authority 5 to give an electronic signature to the EPP public key 99 using the root signature key 109 (S22).

Upon receiving the EPP public key 99 (S23), the certificate authority 5 uses the root signature key 109 to give an electronic signature to the EPP public key 99 (S24). The certificate authority 5 transmits an EPP public key signature 106, which is the given electronic signature, and the root verification key 95 to the encryption keypad 14 (S25).

Upon receiving the EPP public key signature 106 and root verification key 95 (S26), the encryption keypad 14 stores the EPP public key signature 106 and root verification key 95 in the data region 121B (FIG. 4B) of the memory 121 (FIG. 4B) of the encryption keypad controller 110 (S27).

### (1-2-1-3) Flow of Initial Setting of Encryption Key (Host Key)

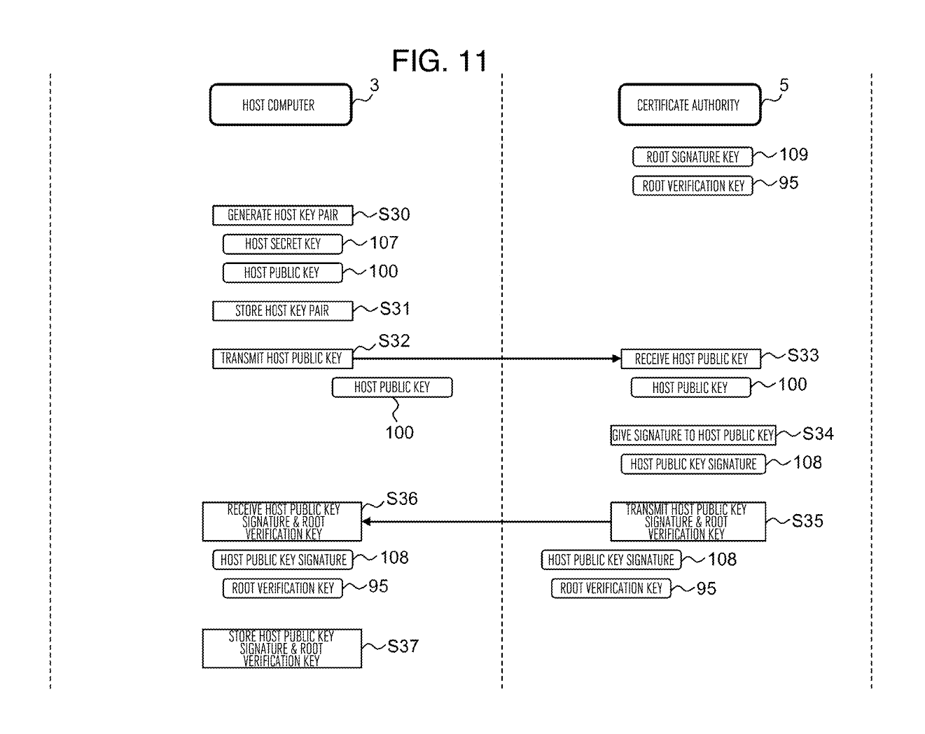

FIG. 11 illustrates the flow of host key setting to set host keys for the core banking host computer 3.

After the certificate authority 5 generates the aforementioned root signature key 109 and root verification key 95 described for FIG. 9, first, the core banking host computer 3 generates an asymmetric host key pair (the host secret key 107 and the host public key 100) (S30). The core banking host computer 3 stores the generated host secret key 107 and host public key 100 in the memory 151B (FIG. 6) of the memory 151 (FIG. 6) (S31).

The core banking host computer 3 transmits the host public key 100 to the certificate authority 5 to give an electronic signature to the host public key 100 using the root signature key 109 (S32).

Upon receiving the host public key 100 (S33), the certificate authority 5 uses the root signature key 109 to give an electronic signature to the host public key 100 (S34). The certificate authority 5 transmits a host public key signature 108, which is the electronic signature given to the host public key 100, and the root verification key 95 to the core banking host computer 3 (S35).

Upon receiving the host public key signature 108 and root verification key 95 (S36), the core banking host computer 3 stores the host public key signature 108 and root verification key 95 in the memory 151B (FIG. 5) of the memory 151 (FIG. 6) (S37).

### (1-2-1-4) Master Key Exchange (CR-EPP)

In the automated transaction system 1 of the first embodiment, in order to securely exchange confidential information between the card reader 13 and encryption keypad 14 and between the card reader 13 and core banking host computer 3, the confidential information is encrypted using a session key. The session key is encrypted using a master key so as to be securely shared by the card reader 13 and encryption keypad 14 and by the card reader 13 and core banking host computer 3.

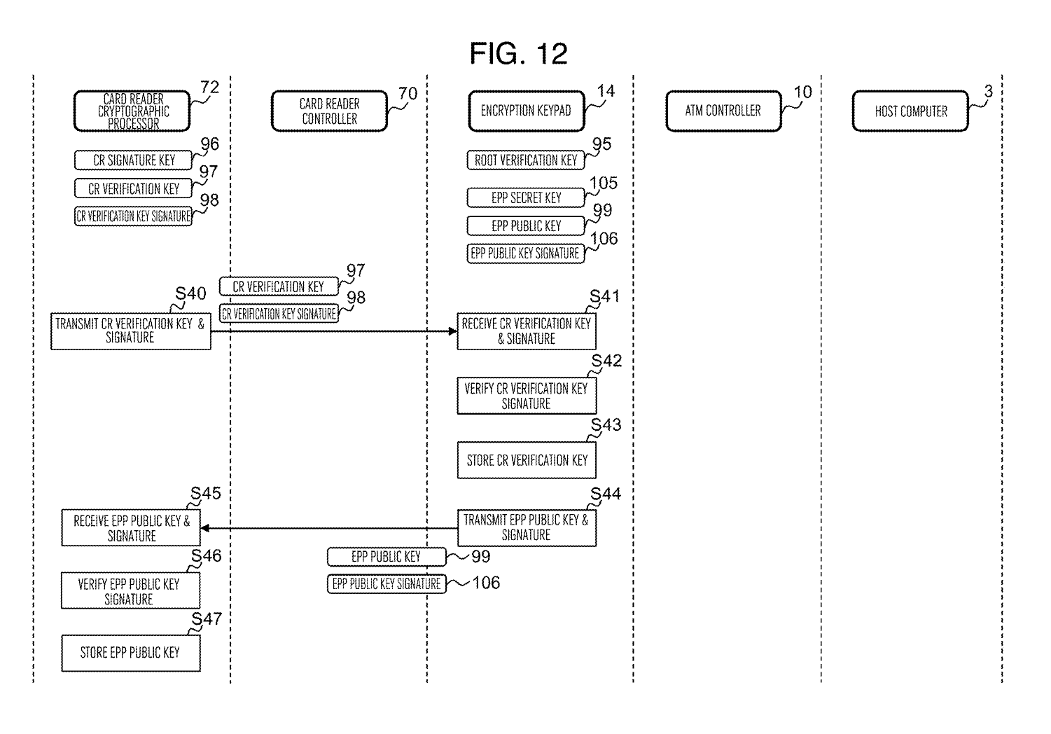

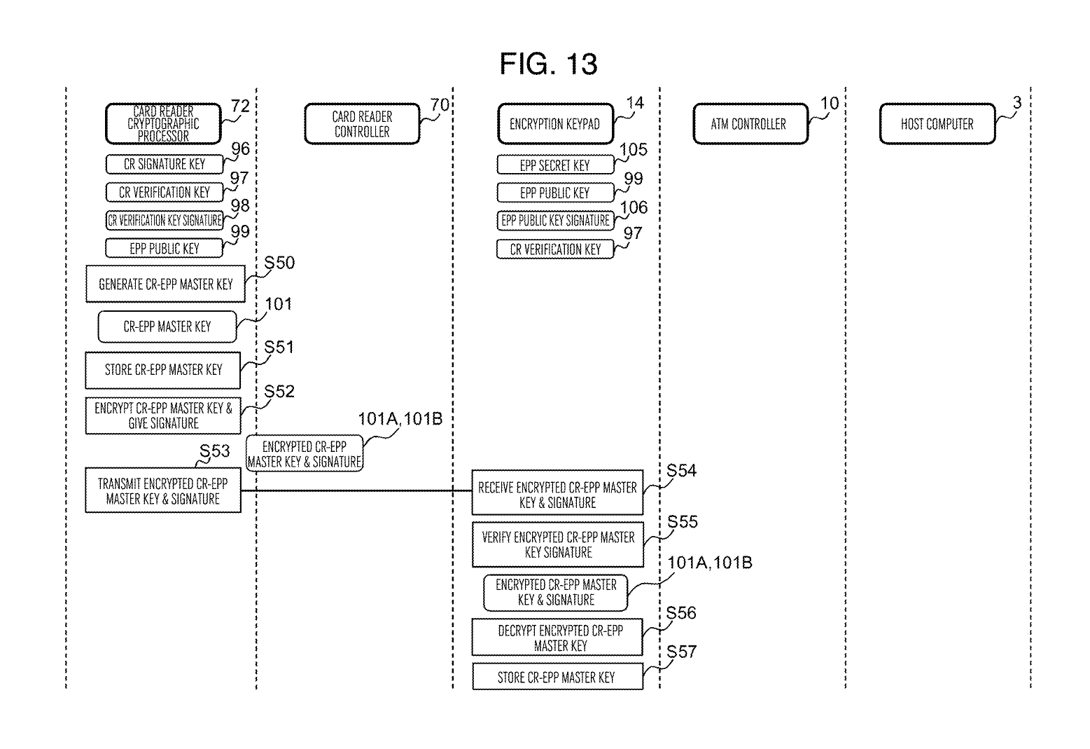

Hereinafter, a description is given of the procedure to securely share the master key between the card reader 13 and encryption keypad 14 with reference to FIGS. 12 and 13.

In this case, first, the card reader cryptographic processor 72 (FIG. 3C) of the card reader 13 transmits the CR verification key 97 and CR verification key signature 98 to the encryption keypad 14 (S40).

Upon receiving the CR verification key 97 and CR verification key signature 98 (S41), the encryption keypad 14 verifies the signature validity of the CR verification key signature 98 using the root verification key 95 (S42). When the signature validity is verified, the encryption keypad 14 stores the CR verification key 97 in the data region 121B (FIG. 4B) of the memory 121 (FIG. 4B) (S43). The encryption keypad 14 transmits the EPP public key 99 and EPP public key signature 106 to the card reader cryptographic processor 72 of the card reader 13 (S44).

Upon receiving the EPP public key 99 and EPP public key signature 106 (S45), the card reader cryptographic processor 72 verifies the signature validity of the EPP public key signature 106 using the root verification key 95 (S46). When the signature validity is verified, the card reader cryptographic processor 72 stores the EPP public key 99 in the data region 91B (FIG. 3C) of the memory 91 (FIG. 3C) (S47).

Subsequently, as illustrated in FIG. 13, the card reader cryptographic processor 72 generates the CR-EPP master key 101 using random numbers (S50) and stores the generated CR-EPP master key 101 in the data region 91B (FIG. 3C) of the memory 91 (FIG. 3C) (S51).

The card reader cryptographic processor 72 encrypts the CR-EPP master key 101 using the EPP public key 99 and gives an electronic signature to the encrypted CR-EPP master key 101 (hereinafter, referred to as an encrypted CR-EPP master key) using the CR signature key 96 (S52). The card reader cryptographic processor 72 then transmits the encrypted CR-EPP master key 101A and the electronic signature 101B to the encryption keypad 14 (S53).

Upon receiving the encrypted CR-EPP master key 101A and electronic signature 101B (S54), the encryption keypad 14 first verifies the validity of the electronic signature 101B using the CR verification key 97 (S55). When the validity is verified, the encryption keypad 14 decrypts the CR-EPP master key 101A using the EPP secret key 105 (S56) and stores the decrypted CR-EPP master key 101 in the data region 121B (FIG. 4B) of the memory 121 (FIG. 4B) (S57).

### (1-2-1-5) Master Key Exchange (CR-Host)

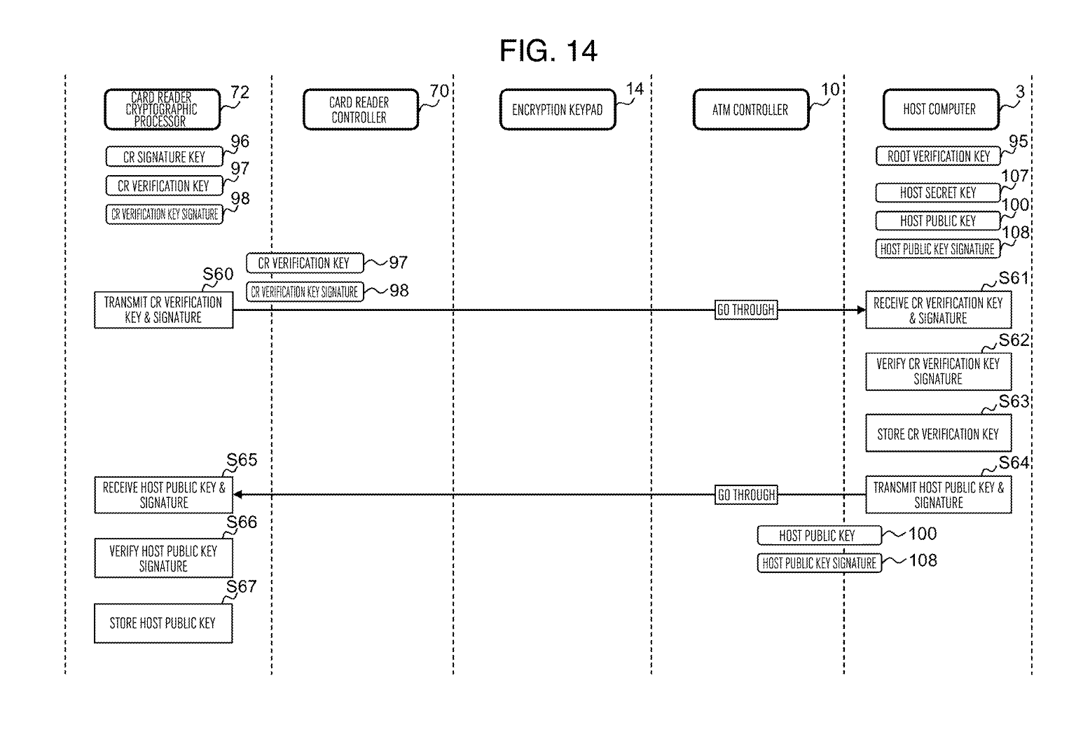

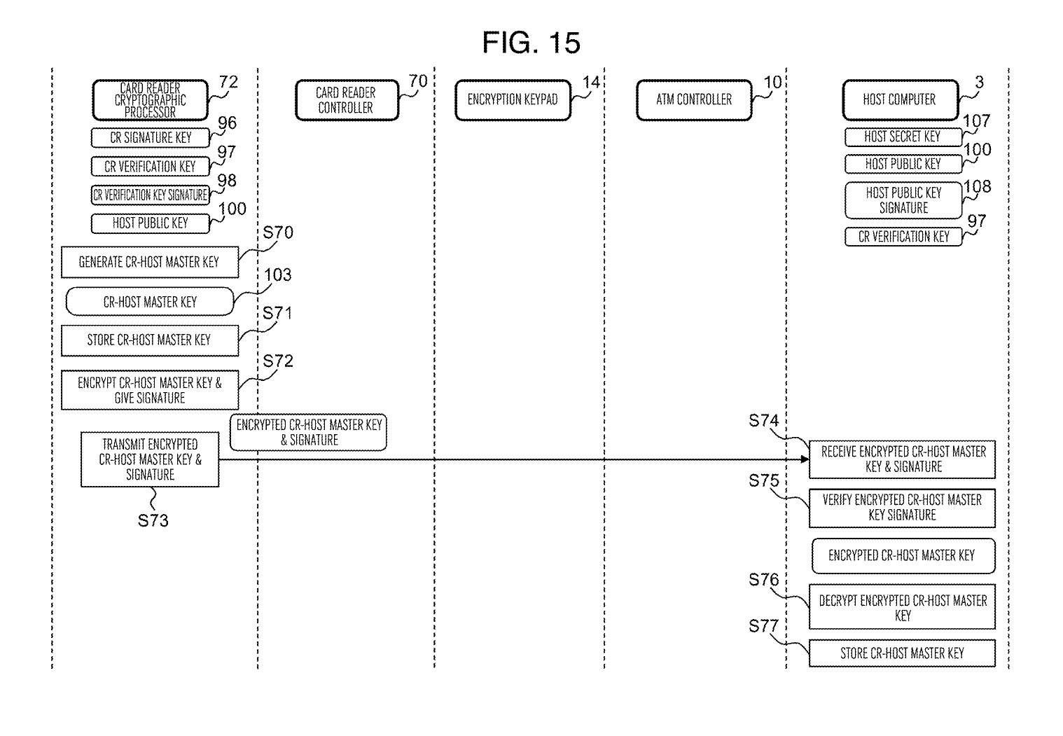

Next, a description is given of the procedure through which the card reader 13 and the core banking host computer 3 share a master key with reference to FIGS. 14 and 15. In this case, the card reader cryptographic processor 72 transmits the CR verification key 97 and CR verification key signature 98 to the core banking host computer 3 (S60).

Upon receiving the CR verification key 97 and CR verification key signature 98 (S61), the core banking host computer 3 verifies the signature validity of the CR verification key signature 98 using the root verification key 95 (S62). When the signature validity is verified, the core banking host computer 3 stores the CR verification key 97 in the memory 151B (FIG. 6) of the memory 151 (FIG. 6) (S63). The core banking host computer 3 then transmits the host public key 100 and host public key signature 108 to the card reader cryptographic processor 72 (S64).

Upon receiving the host public key 100 and host public key signature 108 (S65), the card reader cryptographic processor 72 verifies the signature validity of the host public key signature 108 using the root verification key 95 (S66). When the signature validity is verified, the card reader cryptographic processor 72 stores the host public key 100 in the data region 91B (FIG. 3C) of the memory 91 (FIG. 3C) (S67).

As illustrated in FIG. 15, the card reader cryptographic processor 72 generates the CR-host master key 103 using random numbers (S70) and stores the generated CR-host master key 103 in the data region 91B (FIG. 3C) of the memory 91 (FIG. 3C) (S71).

The card reader cryptographic processor 72 further encrypts the CR-host master key 103 using the host public key 100 and gives an electronic signature to the encrypted host public key 100 (hereinafter, referred to as an encrypted host public key) using the CR signature key 96 (S72). The card reader cryptographic processor 72 then transmits the encrypted CR-host master key and electronic signature to the core banking host computer 3 (S73).

Upon receiving the encrypted CR-host master key and electronic signature (S74), the core banking host computer 3 first verifies the validity of the electronic signature using the CR verification key 97 (S75). When the validity of the electronic signature is verified, the core banking host computer 3 decrypts the encrypted CR-host master key using the host secret key 107 (S76) and stores the thus-obtained decrypted CR-host master key 103 in the memory 151B (FIG. 6) of the memory 151 (FIG. 6) (S77).

### (1-2-1-6) Session Key Exchange (CR-EPP)

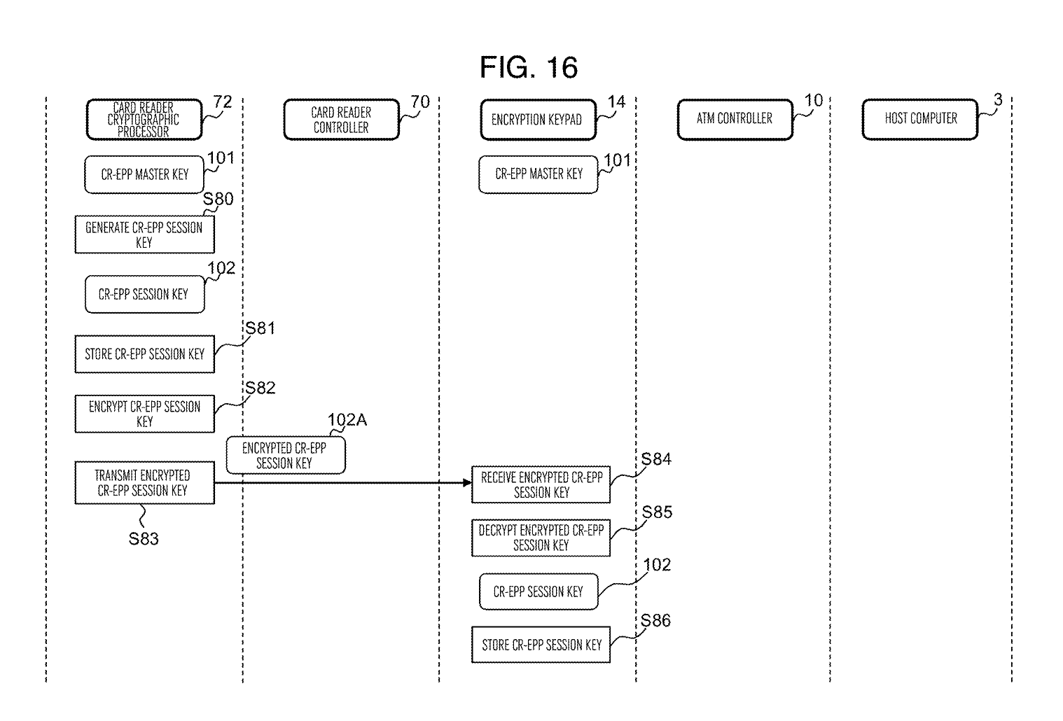

Next, with reference to FIG. 16, a description is given of the procedure through which the card reader 13 and encryption keypad 14 share a session key (the CR-EPP session key 102) used to encrypt necessary card information.

The card reader cryptographic processor 72 first generates the CR-EPP session key 102 using random numbers (S80) and stores the generated CR-EPP session key 102 in the data region 91B (FIG. 3C) of the memory 91 (FIG. 3C) (S81).

The card reader cryptographic processor 72 encrypts the CR-EPP session key 102 using the CR-EPP master key 101 (S82) and then transmits the encrypted CR-EPP session key 102 (hereinafter, referred to as an encrypted CR-EPP session key 102A) to the encryption keypad 14 (S83).

Upon receiving the encrypted CR-EPP session key 102A (S84), the encryption keypad 14 decrypts the CR-EPP session key 102A using the CR-EPP master key 101 (S85) and stores the thus-obtained decrypted CR-EPP session key 102 in the data region 121B (FIG. 4B) of the memory 121 (FIG. 4B) (S86).

### (1-2-1-7) Session Key Exchange (CR-Host)

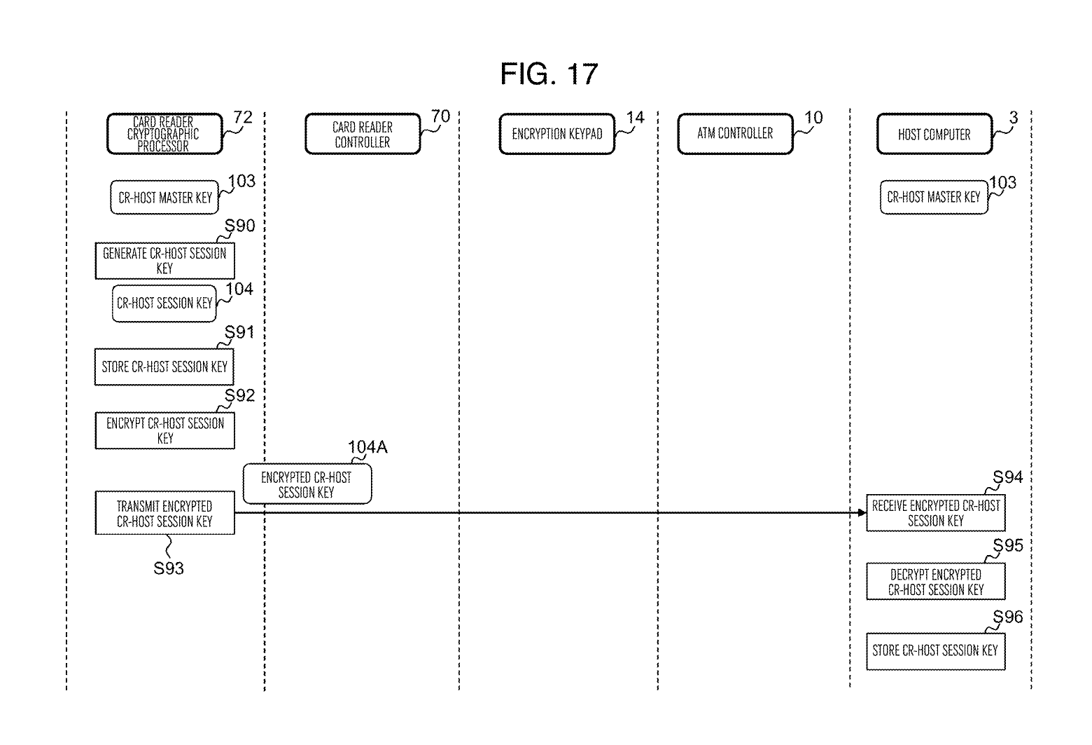

Next, with reference to FIG. 17, a description is given of the procedure through which the card reader 13 and core banking host computer 3 share a session key (a CR-host session key) used to encrypt necessary card information.

The card reader cryptographic processor 72 first generates the CR-host session key 104 using random numbers (S90) and stores the generated CR-host session key 104 in the data region 91B (FIG. 3C) of the memory 91 (FIG. 3C) (S91).

The card reader cryptographic processor 72 encrypts the CR-host session key 104 using the CR-host master key 103 (S92) and then transmits the encrypted CR-host session key 104 (hereinafter, referred to as an encrypted CR-host session key 104A) to the core banking host computer 3 (S93).

Upon receiving the encrypted CR-host session key 104A (S94), the core banking host computer 3 decrypts the CR-host session key 104A using the CR-host master key 103 (S95) and stores the thus-obtained decrypted CR-host session key 104 in the memory 151B (FIG. 6) of the memory 151 (FIG. 6) (S96). In the above description, sharing of the session key is implemented by transmitting the session key encrypted using the master key. However, use of a key sharing method such as derived unique key per transaction (DUKPT) can provide the same effect.

### (1-2-2) Flow of Transaction in First Embodiment

Next, a description is given of the flow of transaction using the IC card 21 (FIG. 1) in the automated transaction system 1 of the first embodiment.

### (1-2-2-1) FIT Update

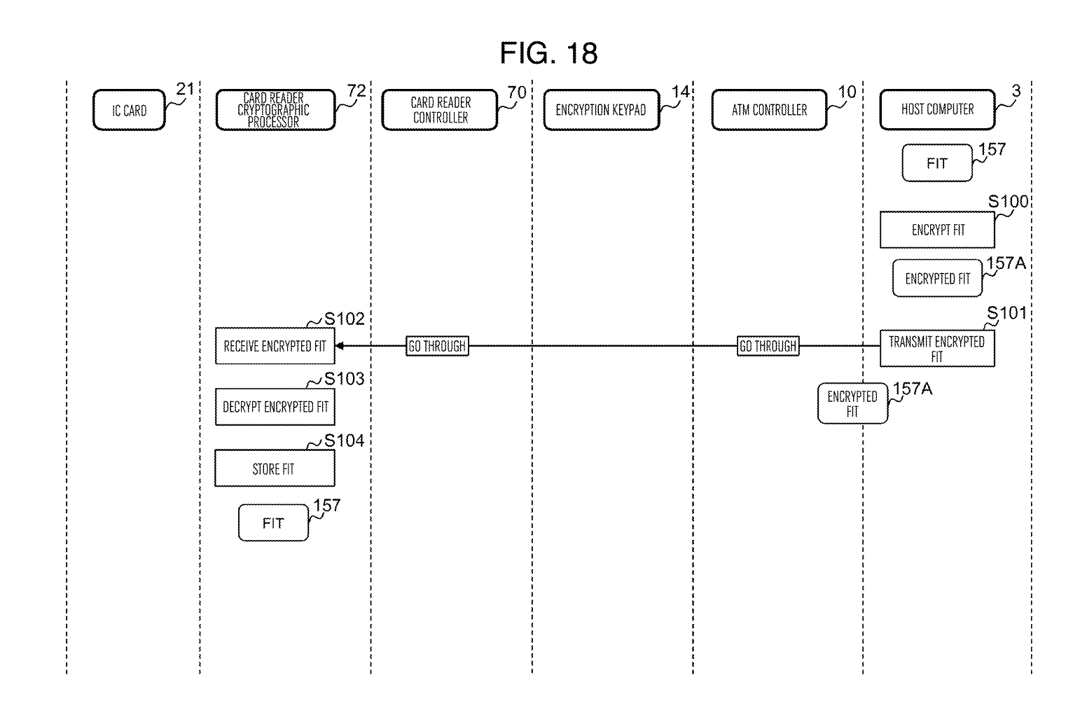

As illustrated in FIG. 18, the FIT 157 (see FIG. 7A) is prepared by the core banking host computer 3. When the FIT 157 in the core banking host computer 3 is updated, it is necessary to update and synchronize the FIT 157 held by the ATM 2 (FIG. 1). In this case, the core banking host computer 3 encrypts the FIT 157 using the CR-host session key 104 (FIG. 17) (S100) and transmits the encrypted FIT (hereinafter, referred to as an encrypted FIT 157A) to the ATM controller 10 (S101). The ATM controller 10 directly transmits the received encrypted FIT 157A to the card reader 13 (FIG. 1).

In the card reader 13, the card reader cryptographic processor 72 receives the encrypted FIT 157A (S102) and decrypts the received encrypted FIT 157A using the CR-host session key 104 (S103). The card reader cryptographic processor 72 stores the original FIT 157 obtained by the decryption, in the data region 91B (FIG. 3C) of the memory 91 (FIG. 3C) (S104).

### (1-2-2-2) Card Reading (Magnetic Information)

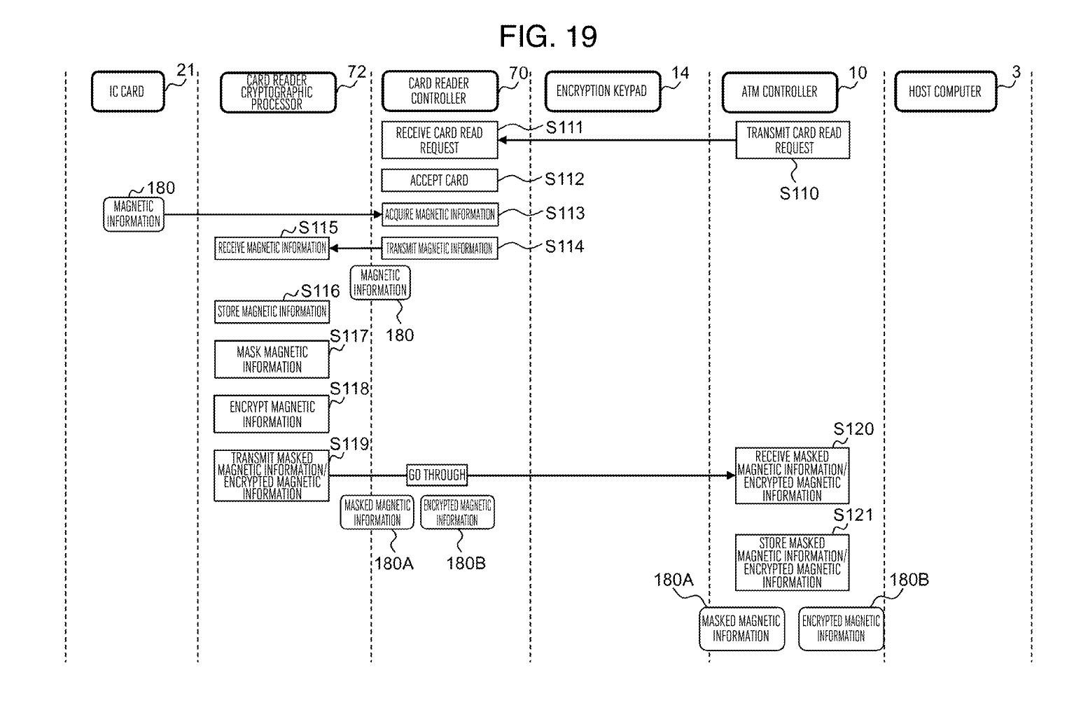

When the user performs a predetermined operation to start a transaction and inserts the IC card 21 into the ATM 2, as illustrated in FIG. 19, the ATM controller 10 transmits a card read request to the card reader controller 70 of the card reader 13 (FIG. 1) (S110).

Upon receiving the card read request (S111), the card reader controller 70 starts a card reading process and accepts the IC card 21 inserted by the user (S112). The card reader controller 70 then causes the card transporting and reading section 71 (FIG. 3A) to read the magnetic information 180 recorded in the magnetic tape on the back of the IC card 21 to acquire the magnetic information 180 (S113). The card reader controller 70 transmits the thus-acquired magnetic information 180 to the card reader cryptographic processor 72 (S114).

Upon receiving the magnetic information 180 (S115), the card reader cryptographic processor 72 stores the received magnetic information 180 in the data region 91B (FIG. 3C) of the memory 91 (FIG. 3C) (S116). The card reader cryptographic processor 72 then also masks the magnetic information 180 (S117) and encrypts the magnetic information 180 (118). The masking refers to hiding some (several middle digits of the PAN, for example) or all of the portion of the magnetic information 180 that stores particular confidential information including the PAN by substituting the same with symbols such as*, characters, or numerals or by another way. The masking includes a process of converting the digits other than the first several digits, to random numbers, like a token PAN, for example. The encryption refers to encrypting the portion of the magnetic information 180 storing the confidential information.

The card reader cryptographic processor 72 then transmits the thus-acquired masked magnetic information 180 (hereinafter, referred to as masked magnetic information 180A) and the encrypted magnetic information 180 (hereinafter, referred to as encrypted magnetic information 180B) to the ATM controller 10 (S119).

Upon receiving the masked magnetic information 180A and encrypted magnetic information 180B (S120), the ATM controller 10 stores the masked magnetic information 180A and encrypted magnetic information 180B in the data region 31B (FIG. 2) of the memory 31 (FIG. 2) (S121).

### (1-2-2-3) FIT Check

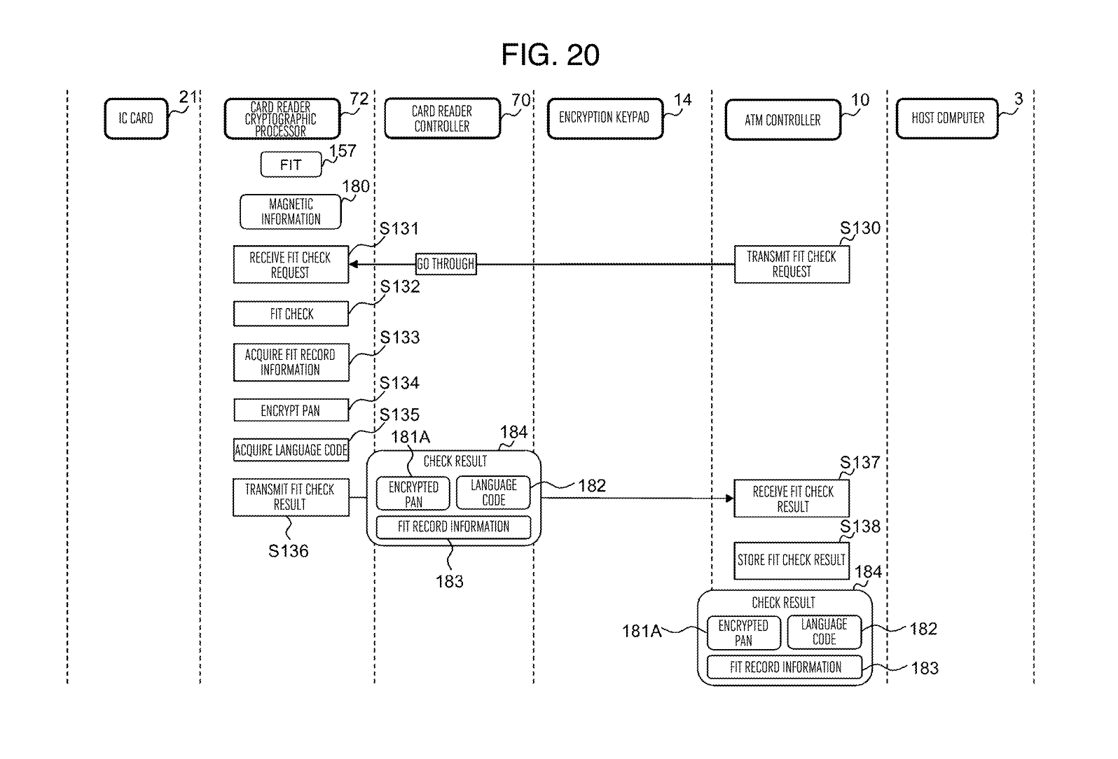

Subsequently, as illustrated in FIG. 20, the ATM controller 10 transmits an FIT check request to the card reader 13 to acquire information necessary for the current transaction (S130).

Upon receiving the FIT check request (S131), the card reader cryptographic processor 72 executes an FIT checking process to check the magnetic information 180 against the FIT 157 (S132). Through the FIT checking process, the card reader cryptographic processor 72 specifies the financial institution having issued the IC card 21 among the information concerning the financial institutions registered in the FIT 157. The card reader cryptographic processor 72 then acquires record information (hereinafter, referred to as FIT record information 183 of the specified financial institution) of the record 160 (FIG. 7A) concerning the specified financial institution (S133).

The card reader cryptographic processor 72 uses the FIT record information 183 to acquire the PAN of the IC card 21 from the magnetic information 180 and encrypts the acquired PAN (S134). The card reader cryptographic processor 72 also uses the FIT record information 183 to acquire the language code of the IC card 21 from the magnetic information 180 (S135).

The card reader cryptographic processor 72 transmits the thus-acquired encrypted PAN (hereinafter, referred to as an encrypted PAN 181A), the language code 182, and the other FIT record information 183 to the ATM controller 10 as an FIT check result 184 (S136).

Upon receiving the FIT check result 184 (S137), the ATM controller 10 stores the received FIT check result 184 in the data region 31B (FIG. 2) of the memory 31 (FIG. 2) (S138).

Based on the language code 182 included in the FIT check result 184 acquired in in the step S137, the ATM controller 10 controls the display section 19 (FIG. 1) so that the display section 19 displays various screens in the language corresponding to the language code 182. In addition, the ATM controller 10 transmits information, including the PIN length and PIN block format contained in the FIT record information 183, to the encryption keypad 14. The encryption keypad 14 accepts the PIN and encrypts the PIN at a transaction based on the above PIN length and PIN block format.

### (1-2-2-4) Card Reading (IC Information)

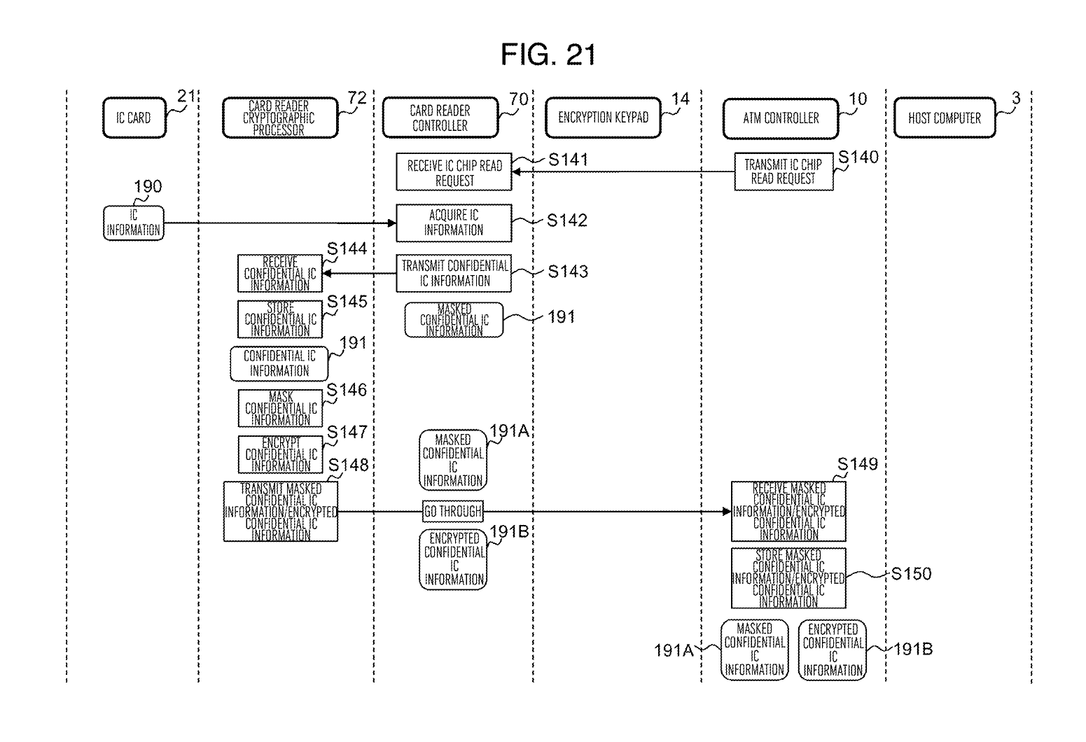

Next, as illustrated in FIG. 21, the ATM controller 10 transmits an IC chip read request to the card reader controller 70 (S140).

Upon receiving the IC chip read request (S141), the card reader controller 70 causes the card transporting and reading section 71 (FIG. 3A) to read IC information 190 from the IC chip mounted in the IC card 21 an acquires the IC information 190 (S142). The card reader controller 70 transmits to the card reader cryptographic processor 72, information 191 that needs to be confidential (including the PAN, aforementioned discretionary information, and the like; hereinafter, referred to as confidential IC information) among the thus acquired IC information 190 (S143).

Upon receiving the confidential IC information 191 (S144), the card reader cryptographic processor 72 stores the received confidential IC information 191 in the data region 91B (FIG. 3C) of the memory 91 (FIG. 3C) (S145).

The card reader cryptographic processor 72 then masks the confidential IC information 191 (S146) and encrypts the confidential IC information 191 (S147). The card reader cryptographic processor 72 then transmits the masked confidential IC information 191 (hereinafter, referred to as masked confidential IC information 191A) and the encrypted confidential IC information 191 (hereinafter, referred to as an encrypted confidential IC information 191B) to the ATM controller 10 (S148). The masking and encryption herein are the same as the masking and encryption performed for the aforementioned magnetic information 180, respectively.

Upon receiving the masked confidential IC information 191A and encrypted confidential IC information 191B (S149), the ATM controller 10 stores the masked confidential IC information 191A and encrypted confidential IC information 191B in the data region 31B (FIG. 2) of the memory 31 (FIG. 2) (S150).

### (1-2-2-5) PIN Entry

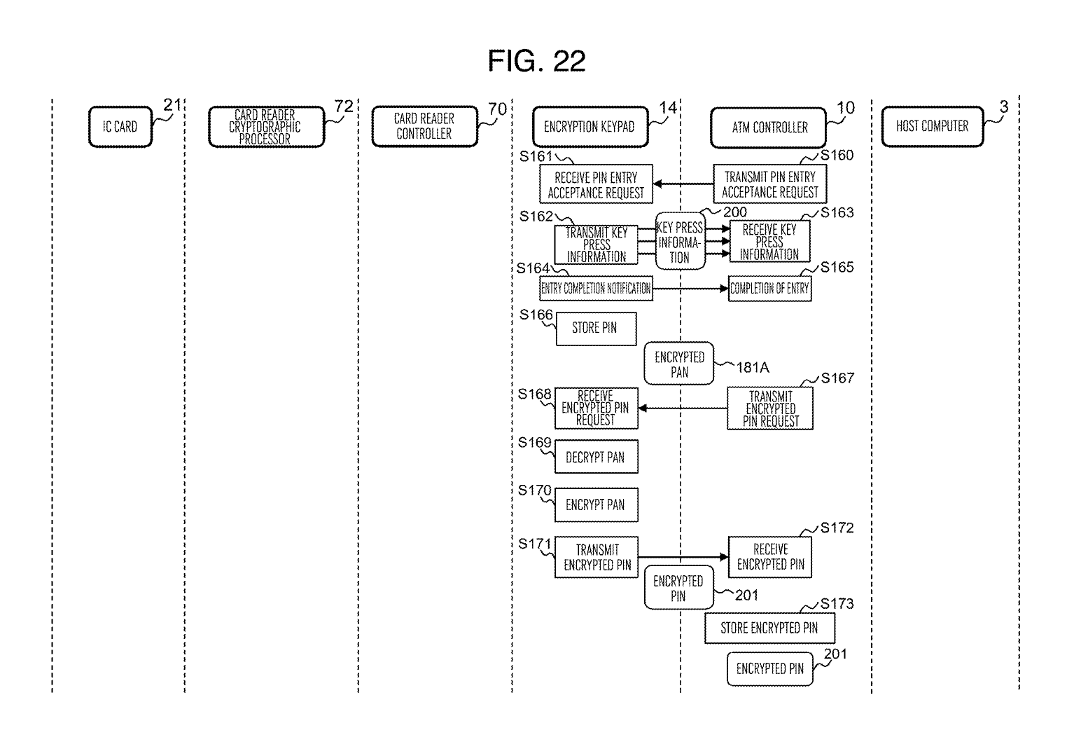

Next, as illustrated in FIG. 22, the ATM controller 10 transmits a PIN entry acceptance request to the encryption keypad 14 (S160). Upon receiving the PIN entry acceptance request (S161), the encryption keypad 14 starts a PIN entry acceptance process and causes the display section 19 (FIG. 1) to display an operation instruction screen that prompts the user to enter the PIN. The encryption keypad 14 then waits for the user to press keys of the keypad 111 (FIG. 4A) of the encryption keypad 14 and enter the PIN.

Each time that the user presses a key of the keypad 111, the encryption keypad 14 transmits to the ATM controller 10, information (hereinafter, referred to as key press information) 200 that the key has been pressed (S162). Note that in the step S162, the encryption keypad 14 only notifies the ATM controller 10 of information that one of the keys has been pressed (hereinafter, referred to as key press information 200) but does not notify the ATM controller 10 of information on which key has been pressed.

Upon receiving the key press information 200 (S163), the ATM controller 10 causes the ATM screen to display information on how many digits of the PIN the user has entered, when needed.

When the entry of the PIN by the user is completed (when the enter key of the keypad 111 is pressed or a specified number of PIN digits have been entered), the encryption keypad 14 transmits to the ATM controller 10, a notification (hereinafter, referred to an entry completion notification) indicating completion of the entry of the PIN (S164). Based on the entry completion notification, the ATM controller 10 recognizes completion of the entry of the PIN (S165). The ATM controller 10 may be configured to determine completion of the entry of the PIN based on the number of digits that have been entered. The encryption keypad 14 then stores the PIN entered by the user in the data region 121B (FIG. 4B) of the memory 121 (FIG. 4B) (S166).

The ATM controller 10 then requests transfer of the encrypted PIN from the encryption keypad 14 (hereinafter, the request is referred to as an encrypted PIN transfer request) (S167). Some methods of encrypting the PIN require the PAN. In such a case, the encrypted PAN 181A is transmitted together with the encrypted PIN transfer request. The encrypted PAN 181A is contained in the FIT check result 184 (FIG. 20) stored in the data region 31B (FIG. 2) of the memory 31 (FIG. 2) by the ATM controller 10 in the step S138 of the process described above with reference to FIG. 20.

Upon receiving the encrypted PIN transfer request (S168), the encryption keypad 14 decrypts the encrypted PAN 181A if necessary (S169) and encrypts the PIN using the decrypted PAN (S170). The encryption keypad 14 transmits the encrypted PIN (hereinafter, referred to as an encrypted PIN) 201 to the ATM controller 10 (S171).

Upon receiving the encrypted PIN 201 (S172), the ATM controller 10 stores the received encrypted PIN 201 in the data region 31B (FIG. 2) of the memory 31 (FIG. 2) (S173).

### (1-2-2-6) Transaction Amount Entry

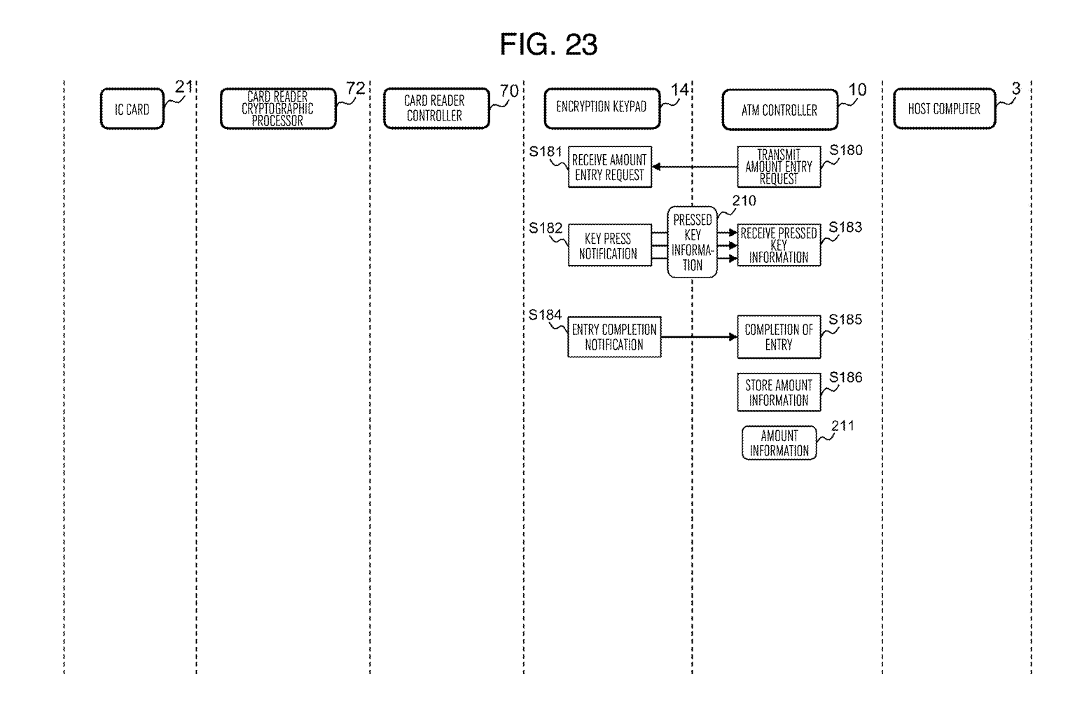

As illustrated in FIG. 23, the ATM controller 10 transmits to the encryption keypad 14, an amount entry request to prompt the user to enter the transaction amount (S180). Upon receiving the amount entry request (S181), the encryption keypad 14 starts an amount entry process and causes the display section 19 (FIG. 1) to display an operation instruction screen that prompts the user to enter a transaction amount. The encryption keypad 14 then waits for the user to press keys of the keypad 111 (FIG. 4A) and enter a transaction amount.

Each time that the user presses a key of the keypad 111, the encryption keypad 14 notifies the ATM controller 10 of the value of the pressed key as pressed key information 210 (S182). Upon receiving the pressed key information 210 (S183), based on the received pressed key information 210, the ATM controller 10 causes the ATM screen to display the transaction amount which is entered by the user until then, as amount information.

When the enter key of the keypad 111 is pressed, that is, the entry of the transaction amount by the user is completed, the encryption keypad 14 makes a notification (entry completion notification) that indicates completion of the entry to the ATM controller 10 (S184). Based on the entry completion notification, the ATM controller 10 recognizes completion of the entry of the transaction amount (S185).

The ATM controller 10 stores the transaction amount entered by the user in the data region 31B (FIG. 2) of the memory 31 (FIG. 2) as amount information 211 (S186).

### (1-2-2-7) Card Authentication Data Request

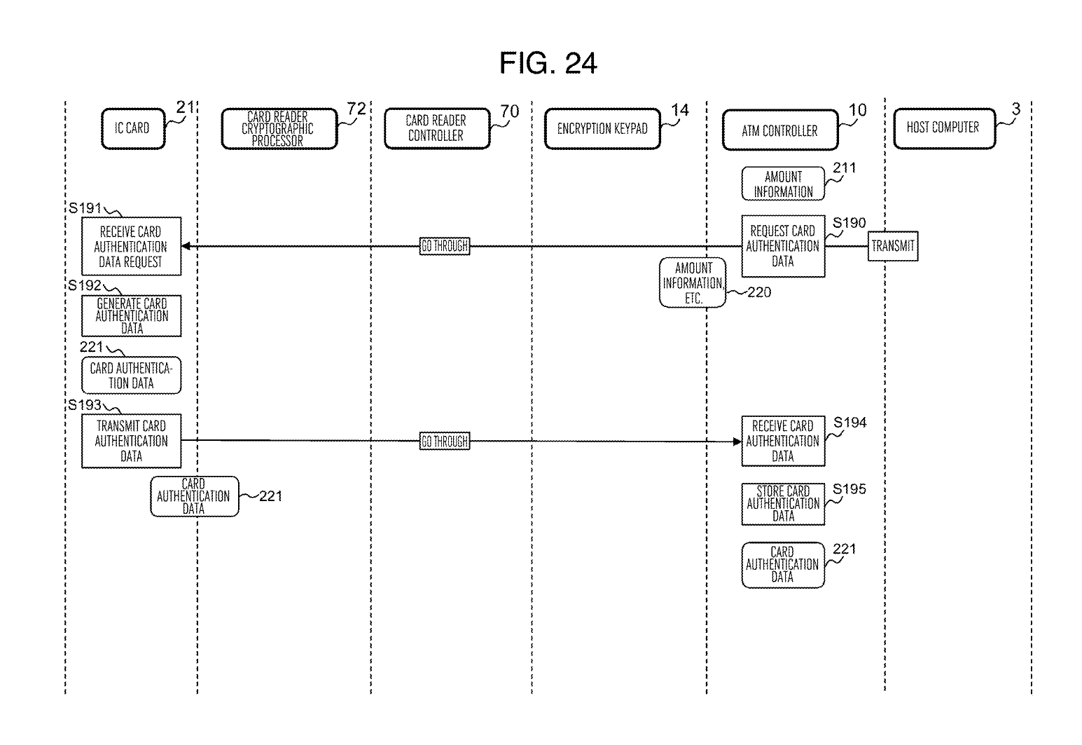

Subsequently, as illustrated in FIG. 24, the ATM controller 10 transmits a card authentication data generation request that requests generation of card authentication data, from the IC card 21 via the card reader controller 70 (S190). In this process, the ATM controller 10 transmits information 220, including the transaction amount, necessary for creating the card authentication data, to the IC card 21 together with the card authentication data generation request.

Upon receiving the card authentication data generation request (S191), the IC card 21 generates card authentication data 221 using the information 220 transmitted together with the card authentication data generation request (S192). The IC card 21 transmits the generated card authentication data 221 to the ATM controller 10 via the card reader controller 70 (S193).

Upon receiving the card authentication data 221 (S194), the ATM controller 10 stores the card authentication data 221 in the data region 31B (FIG. 2) of the memory 31 (FIG. 2) (S195).

### (1-2-2-8) Transaction Request

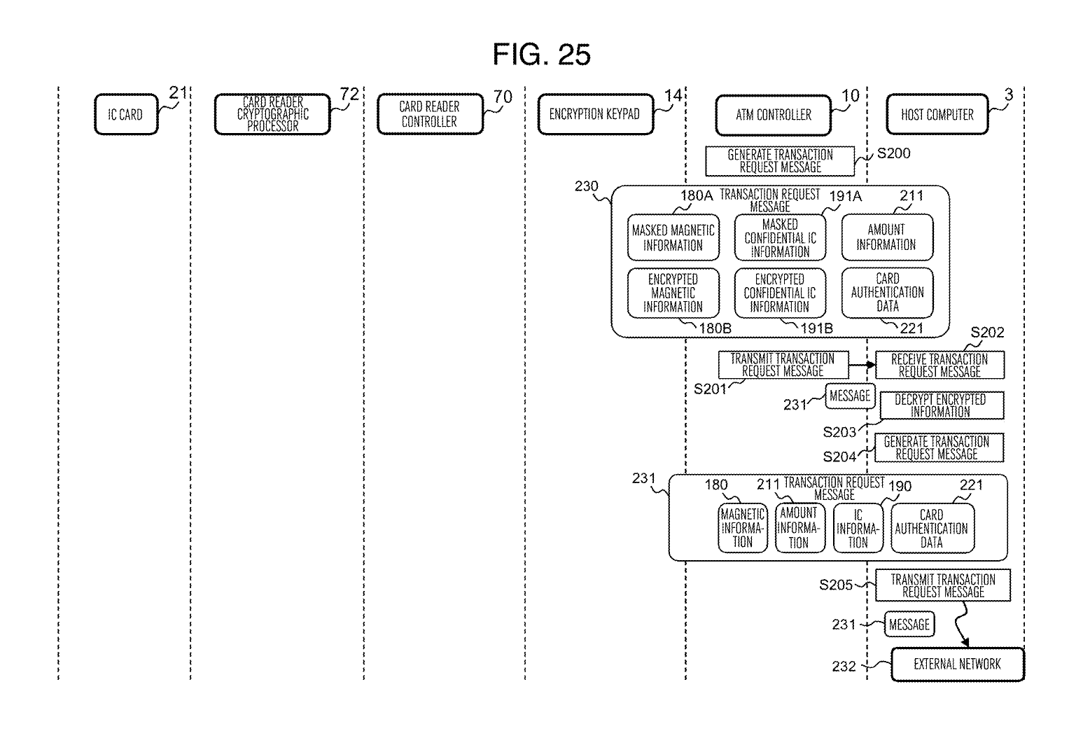

As illustrated in FIG. 25, the ATM controller 10 then generates a transaction request message 230 for the core banking host computer 3 based on the information stored in the data region 31B of the memory 31 during the above-described processes, including the masked magnetic information 180A, the encrypted magnetic information 180B, the masked confidential IC information 191A, the encrypted confidential IC information 191B, the amount information 211, and the card authentication data 221 (S200). The ATM controller 10 then transmits the generated transaction request message 230 to the core banking host computer 3 (S201).

Upon receiving the transaction request message 230 (S202), the core banking host computer 3 decrypts the encrypted magnetic information 180B and encrypted confidential IC information 191B included in the received transaction request message 230 (S203). The core banking host computer 3 then uses the magnetic information 180, the IC information 190, and the like obtained by the decryption to generate a transaction request message 231 (S204)

The core banking host computer 3 transmits the generated transaction request message 231 to a card bland issuer (not illustrated) via an external network 232 (S205).

### (1-2-2-9) Transaction Response

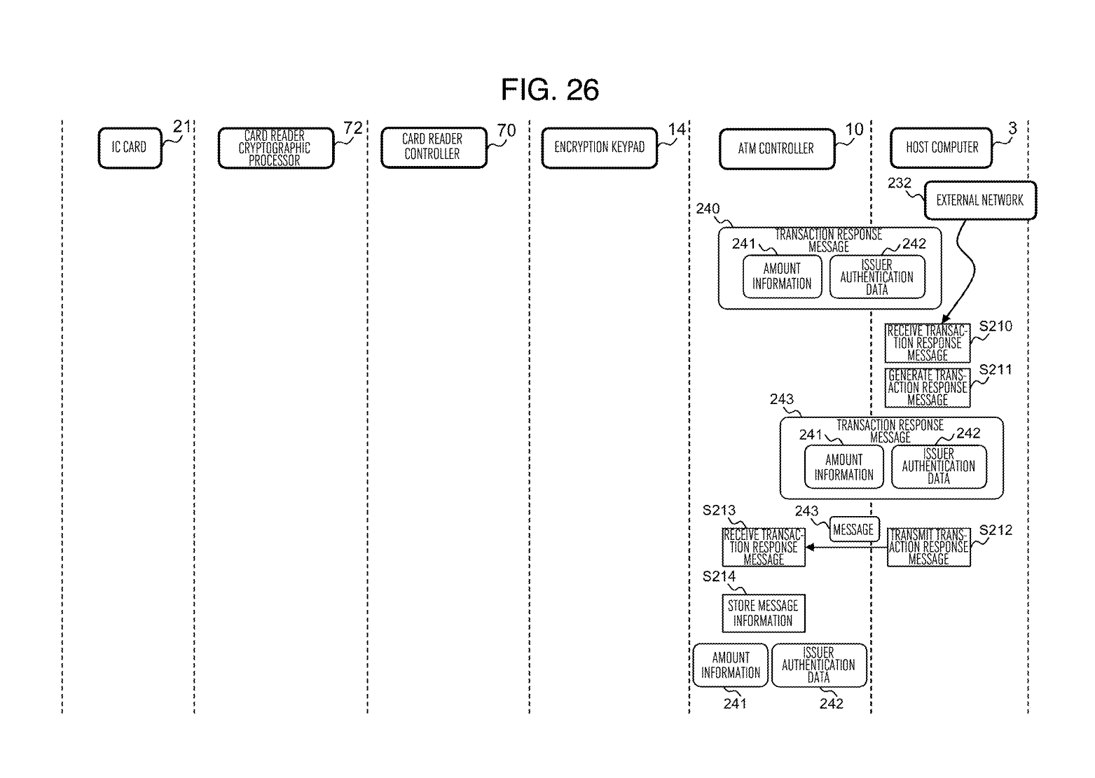

As illustrated in FIG. 26, the core banking host computer 3 then receives a transaction response message 240 corresponding to the aforementioned transaction request message 231 from the card brand issuer (not illustrated) via the external network 232 (S210). The transaction response message 240 includes amount information 241, issuer authentication data 242, and the like.

Upon receiving the transaction response message 240, based on the received information, the core banking host computer 3 generates a transaction response message 243 for the ATM controller 10 (S211). The core banking host computer 3 transmits the generated transaction response message 243 to the ATM controller 10 (212). The transaction response message 243 includes the amount information 241 and issuer authentication data 242.

Upon receiving the transaction response message 243 (S213), the ATM controller 10 stores message information contained in the transaction response message 243, including the amount information 241, the issuer authentication data 242, and the like, in the data region 31B (FIG. 2) of the memory 31 (FIG. 2) (S214).

### (1-2-2-10) Issuer Authentication and Withdrawal

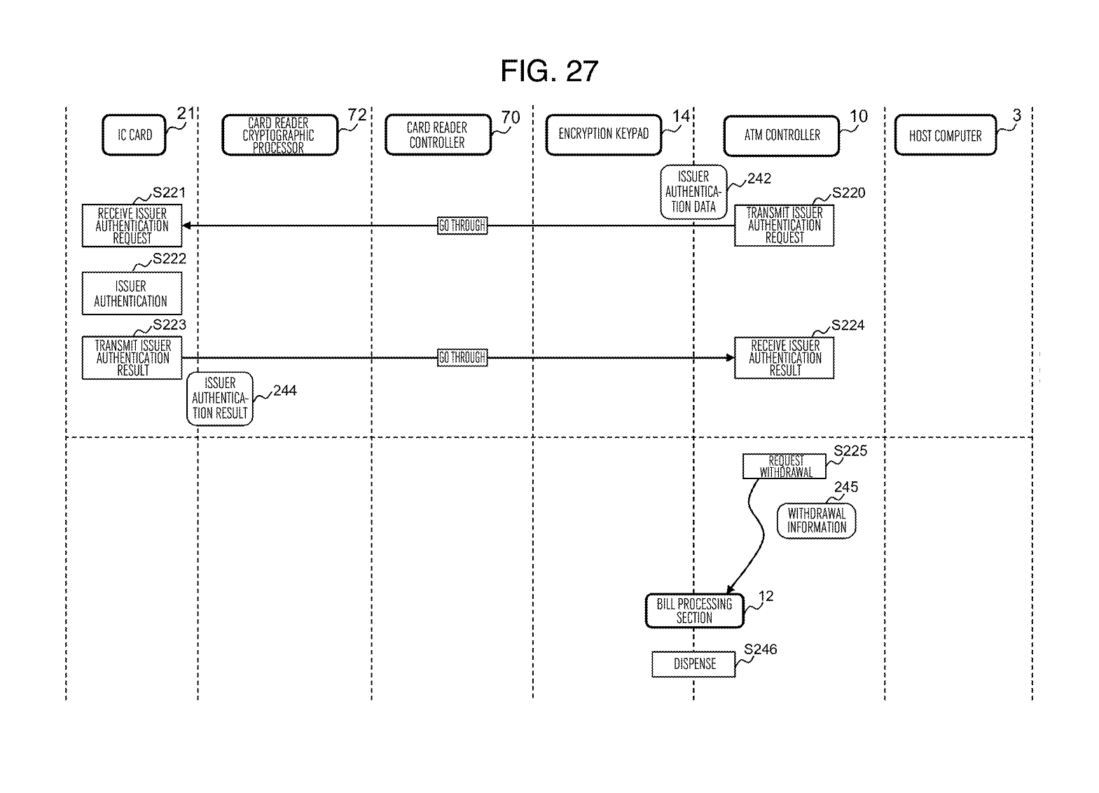

As illustrated in FIG. 27, the ATM controller 10 transmits the issuer authentication data 242 and an issuer authentication request that requests issuer authentication to the IC card 21 via the card reader controller 70 (S220).

Upon receiving the issuer authentication data 242 and issuer authentication request (S221), the IC card 21 executes issuer authentication (S222). The IC card 21 transmits the results of the executed issuer authentication to the ATM controller 10 as an issuer authentication result 244 (S223).

Upon receiving the issuer authentication result 244 (S224), the ATM controller 10 determines whether the issuer authentication is successful. When the issuer authentication is successful, the ATM controller 10 transmits withdrawal information 245, including the amount of money to be dispensed, and a withdrawal request to the bill processing section 12 (S225). Upon receiving the withdrawal request, the bill processing section 12 dispenses the amount of money based on the received withdrawal information (S226).

### (1-3) Effect of First Embodiment

As described above, in the automated transaction system 1 of the first embodiment, the card reader cryptographic processor 72 (FIG. 3C) of the card reader 13 holds the FIT 157 (FIG. 7A). The card reader cryptographic processor 72 refers to the FIT 157 to encrypt confidential information including the PAN among card information (the magnetic information 180 (FIG. 19) and the confidential IC information 191 (FIG. 21)) read from the IC card 21 and then transmits necessary card information to the core banking host computer 3 via the ATM controller 10.

According to the first embodiment, even if the ATM controller 10 of the ATM 2 is infected with malware and leaks card information, it is possible to prevent leakage of the PAN necessary for creation of a counterfeit card or improper use for Internet shopping since confidential information is encrypted. This can implement a highly-reliable automated transaction system.

According to the first embodiment, moreover, the ATM controller 10 does not handle card numbers which are not encrypted. The ATM controller 10 can therefore be eliminated from the objects for certificate by payment card industry data security standards (PCIDSS). This effectively facilitates certification of the ATM 2 by the PCIDSS.

### (2) Second Embodiment

In the description of the first embodiment, the card reader cryptographic processor 72 processes the FIT 157 (FIG. 7A). The ATM controller 10 may hold the FIT 157 under the conditions that the FIT 157 includes only not-confidential digits in the financial institution number. The following description is given of such a case as a second embodiment. The following description is given of only different points of the procedure to carry out a transaction using the IC card 21 from those of the first embodiment.

### (2-1) Configuration of Automated Transaction System of Second Embodiment

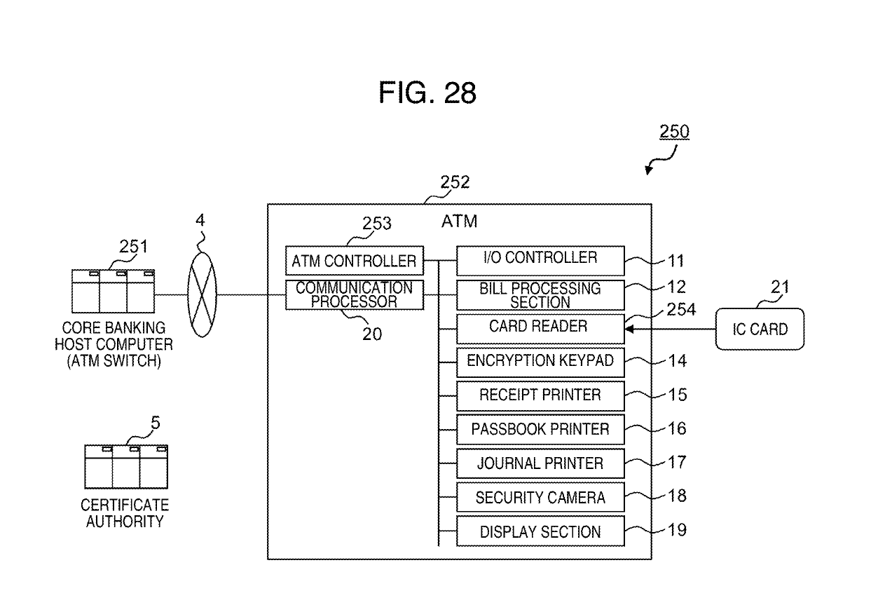

FIG. 28 illustrates an automated transaction system 250 according to the second embodiment. In FIG. 28, the same portions as those of FIG. 1 are given the same reference numerals. The automated transaction system 250 includes the same configuration as that of the automated transaction system 1 (FIG. 1) of the first embodiment except a core banking host computer 251 and functions concerning some processes of an ATM controller 253 and a card reader 254 of an ATM 252.

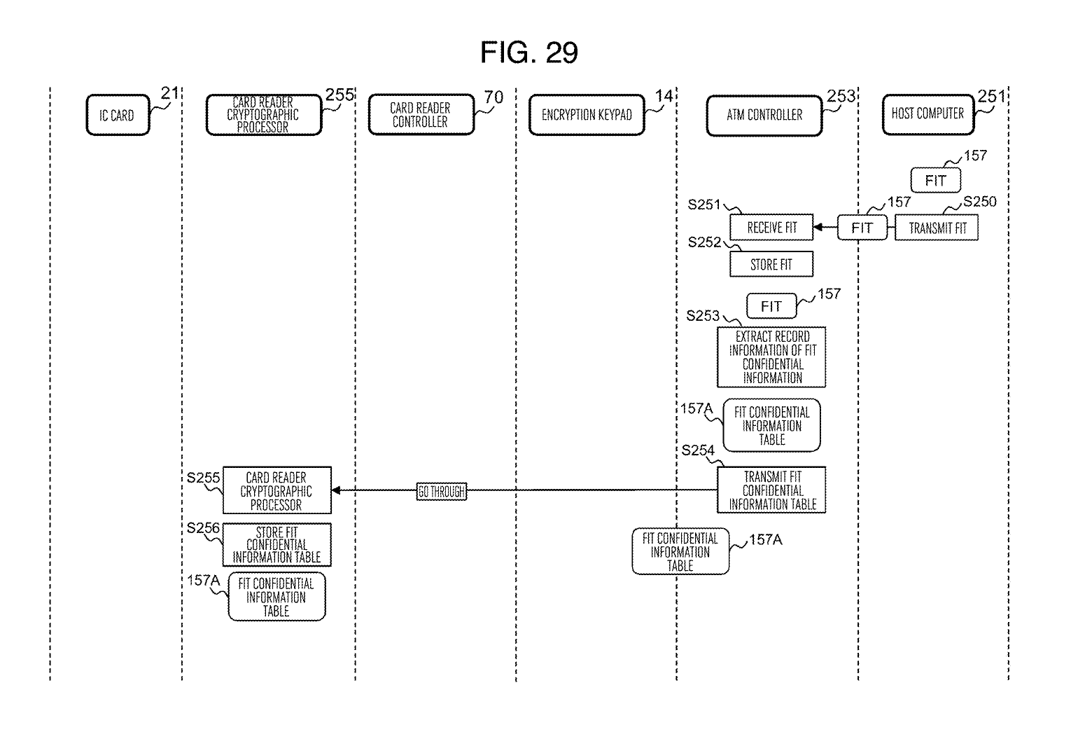

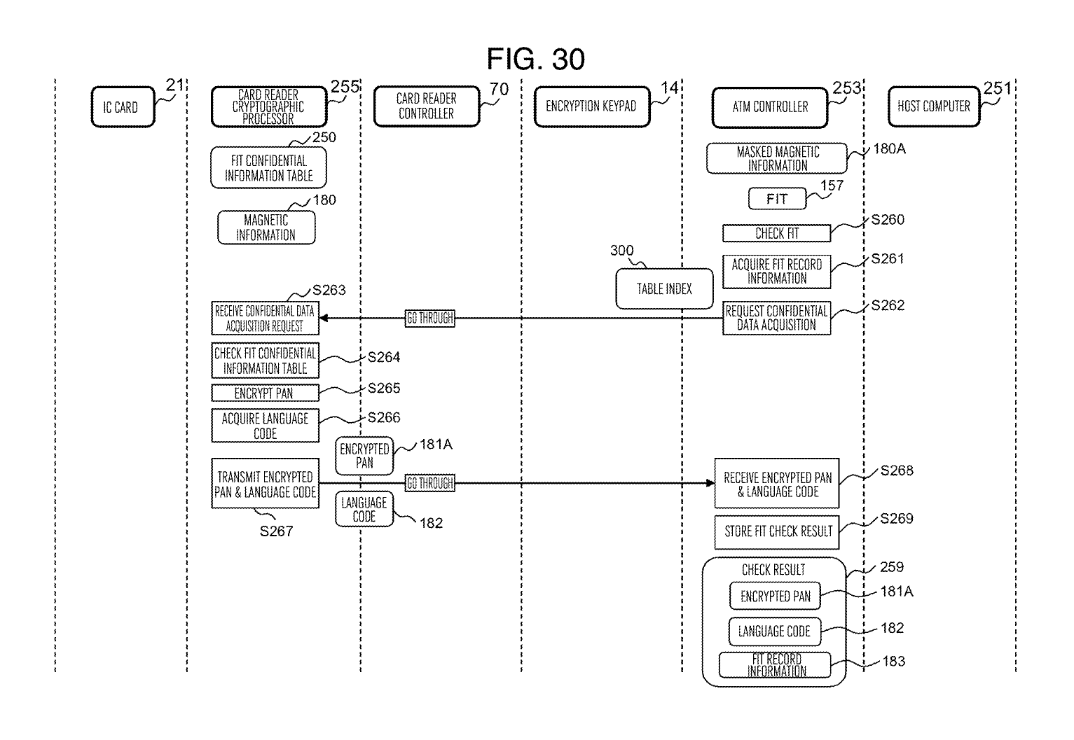

In this case, the core banking host computer 251 includes the same configuration as that of the core banking host computer 3 of the first embodiment except an FIT update-related process (described later for FIG. 29) that the CPU 150 (FIG. 6) executes based on the host application 152 (FIG. 6) stored in the memory 151 and an FIT check-related process described later for FIG. 30.

The ATM 252 includes the same configuration as that of the ATM 2 of the first embodiment except a process (described later for FIGS. 29 and 30) that the CPU 30 (FIG. 2) of the ATM controller 253 executes based on the ATM application 40 (FIG. 2) stored in the memory 31 and a process (described later for FIGS. 29 and 30) that the CPU 90 (FIG. 3C) of the card reader cryptographic processor 255 (FIG. 29) of the card reader 254 executes based on the application 92 (FIG. 3C) stored in the memory 91 (FIG. 3C).

### (2-2) FIT Update

FIG. 29 illustrates the processing procedure of an FIT update process that is executed in the automated transaction system 250 of the second embodiment instead of the FIT update process of the first embodiment described above for FIG. 18. In the second embodiment, as illustrated in FIG. 29, the FIT 157 is prepared in the core banking host computer 251 (FIG. 28) in a similar manner to the first embodiment. When the FIT 157 is updated, it is necessary to update and synchronize the FIT 157 held by the ATM 252 (FIG. 28).

In the second embodiment, the core banking host computer 251 transmits the updated FIT 157 to the ATM controller 253 of the ATM 252 (S250). Upon receiving the FIT 157 (S251), the ATM controller 253 stores the received updated FIT 157 in the data region 31B (FIG. 2) of the memory 31 (FIG. 2) and an external storage device composed of a not-illustrated hard disk drive or the like within the ATM 252 (S252).

As illustrated in FIG. 7B, the ATM controller 253 extracts the information 161, 162, 164, 165, and 166 of the items (herein, the financial institution ID offset, financial institution ID, PAN offset, PAN length, and language code offset in the record information of the record 160 (FIG. 7A) of each financial institution) relating to confidential information among various types of information specific to each financial institution in the FIT 157 for each financial institution as a record 160A of the financial institution and generates an FIT confidential information table 157A, which is a subset of the FIT 157 (S253). The ATM controller 253 transmits the thus generated FIT confidential information table 157A to the card reader 254 (FIG. 28) (S254).

In the card reader 254, a card reader cryptographic processor 255 receives the FIT confidential information table 157A via the card reader controller 70 (S255) and stores the received FIT confidential information table 157A in the data region 91B (FIG. 3C) of the memory 91 (FIG. 3C) (S256).

### (2-3) FIT Check

FIG. 30 illustrates the processing procedure of an FIT check process that is executed in the automated transaction system 250 of the second embodiment instead of the FIT check process of the first embodiment described above for FIG. 20.

In the second embodiment, the ATM controller 253 checks the masked magnetic information 180A against the FIT 157 (S260). The ATM controller 253 then acquires record information other than the confidential data (the PAN and language code) of the record 160 of the corresponding financial institution based on the check result (S261). With reference to the reference result in the step S260, the ATM controller 253 transmits a table index 300 to the card reader 254 (FIG. 28) to request acquisition of confidential data contained in the corresponding record 160 (S262). The table index 300 includes a number indicating the ranking of the record 160 of the corresponding financial institution among the records 160 of the financial institutions registered in the FIT 157.

Upon receiving the aforementioned request via the card reader controller 70 (S263), the card reader cryptographic processor 255 of the card reader 254 starts a process to acquire confidential data. The card reader cryptographic processor 255 first checks the magnetic information 180 against the FIT confidential information table 157A (FIG. 7B) to acquire the information 164 of the PAN offset (FIG. 7B) from the record 160A corresponding to the table index 300 in the FIT confidential information table 157A (S264). The card reader cryptographic processor 255 uses the acquired information 164 of the PAN offset to acquire the PAN and language code from the magnetic information 180 and encrypts the acquired PAN to generate an encrypted PAN 181A (S265).

The card reader cryptographic processor 255 uses the information 166 (FIG. 7B) of the language code offset acquired from the FIT confidential information table 157A to acquire the language code 182 from the magnetic information 180 (S266). The card reader cryptographic processor 255 transmits to the ATM controller 253, the thus-generated encrypted PAN 181A and thus-acquired language code 182 (S267).

Upon receiving the encrypted PAN 181A and language code 182 (S268) via the card reader controller 70 (S268), the ATM controller 253 stores the received encrypted PAN 181A and language code 182 and the other results 259 from checking the FIT 157 and FIT confidential information table 157A, in the data region 31B (FIG. 2) of the memory 31 (FIG. 2) (S269).

### (2-4) Effect of Second Embodiment

As described above, in the automated transaction system 250 of the second embodiment, the card reader cryptographic processor 255 of the card reader 254 (FIG. 28) holds the FIT confidential information table 157A, which includes only the information 161, 162, and 164 to 166 that are used to acquire confidential information and are extracted from the information 161 to 167 included in the FIT 157. The card reader cryptographic processor 255 acquires the PAN from the magnetic information 180 read from the IC card 21 based on the FIT confidential information table 157A, encrypts the acquired PAN, and transmits the encrypted PAN to the ATM controller 253. The ATM controller 253 holds the FIT 157 and acquires acquirable card information from the masked magnetic information 180A by referring to the FIT 157.

In this case, the amount of data of the FIT confidential information table 157A is significantly smaller than the amount of data of the FIT 157. According to the automated transaction system 250 of the second embodiment, in addition to the effects provided by the automated transaction system 1 of the first embodiment, it is possible to reduce the memory capacity of the memory 91 (FIG. 3C) to hold a table that is necessary for the card reader cryptographic processor 255 of the card reader 254 to acquire the PAN from the IC card 21.

In the automated transaction system 250, only the PAN and language code are acquired from the card reader cryptographic processor 255 as described above. The process to acquire the card information from the magnetic information 180 is thus shared by the card reader cryptographic processor 255 and the ATM controller 253. This reduces processing load on the card reader cryptographic processor 255 and reduces the processing time of the card reader cryptographic processor 255 concerning acquisition of the card information.

### (3) Third Embodiment

### (3-1) Summary and Configuration of Automated Transaction System of Third Embodiment

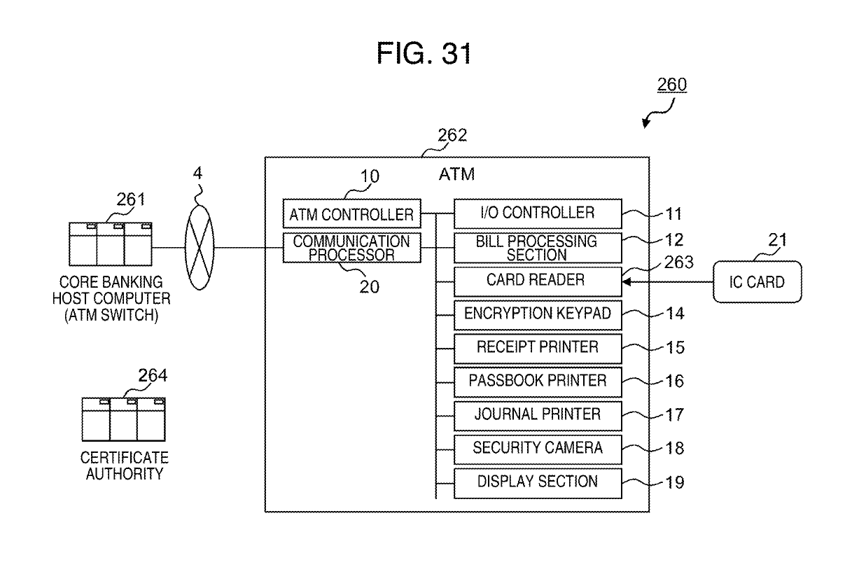

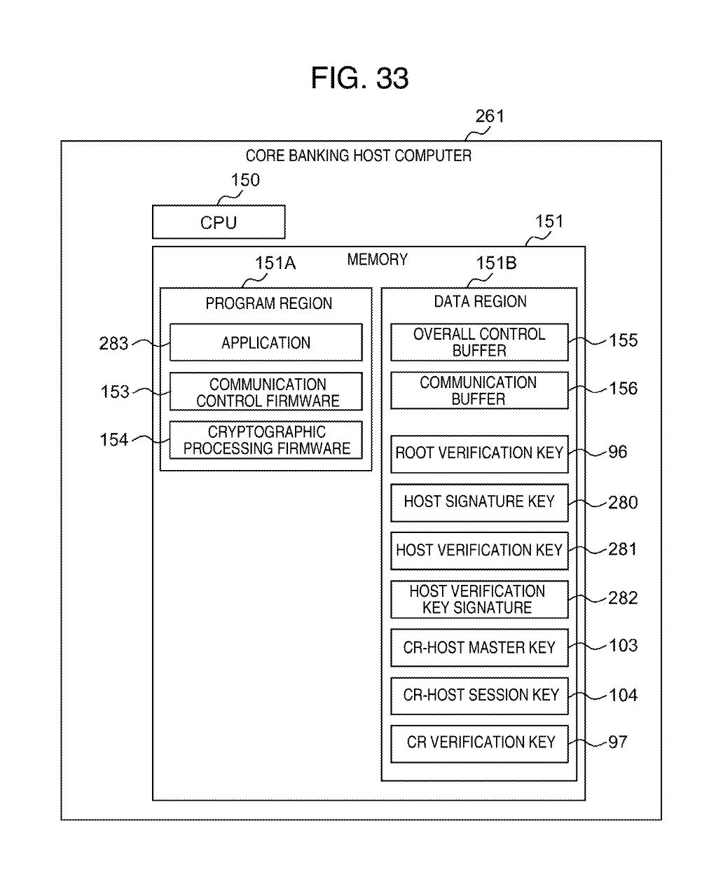

Next, with reference to FIGS. 31 to 37, an automated transaction system 260 (FIG. 31) according to the third embodiment is described. The automated transaction system 260 of the third embodiment is characterized in that the CR-host master key 103 (FIG. 33) is generated by a core banking host computer 261, and the generated CR-host master key 103 is transmitted from the core banking host computer 261 to a card reader 263 of an ATM 262. The other part has the same configuration as that of the automated transaction system 1 (FIG. 1) of the first embodiment.

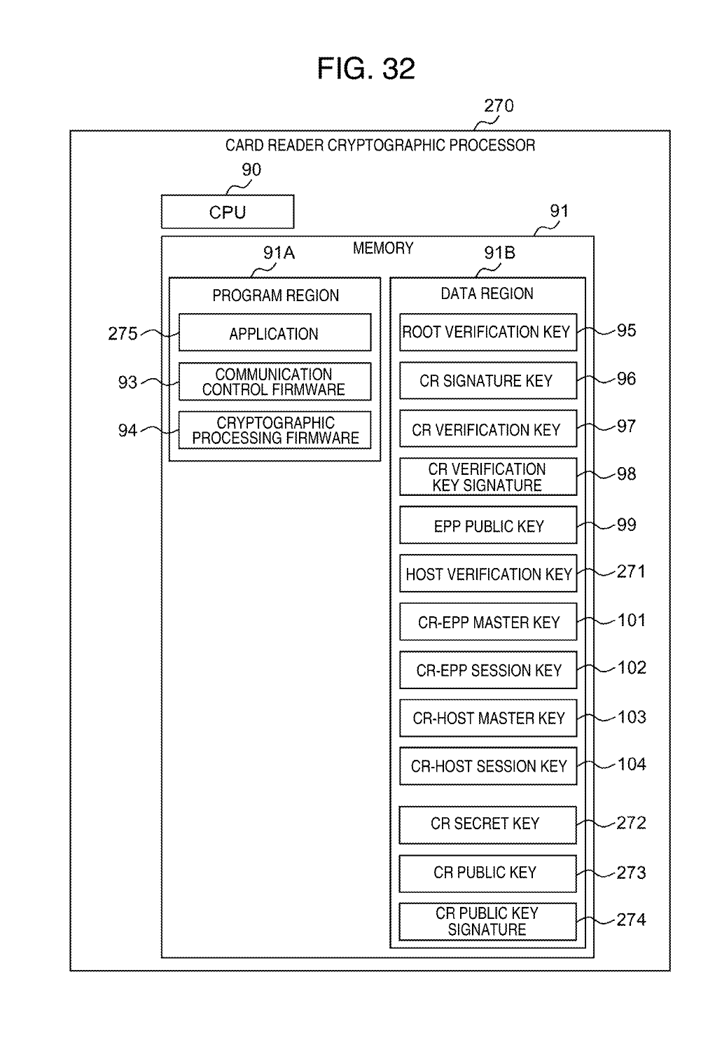

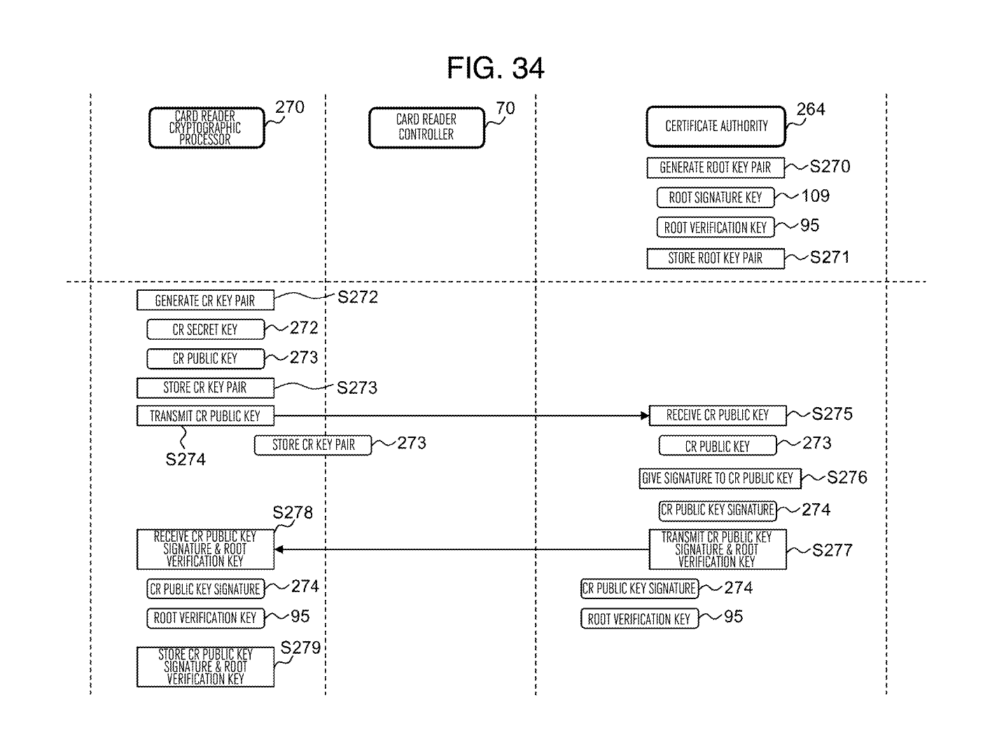

As illustrated in FIG. 32, during later-described various types of processing, a card reader cryptographic processor 270 of the card reader 263 of the third embodiment properly holds a host verification key 271 in the data region 91B of the memory 91 instead of the host public key 100 in FIG. 3C and properly holds a CR secret key 272 and a CR public key 273 in the data region 91B of the memory 91. In FIG. 32, the same portions as those in FIG. 3C are given the same reference numerals. The other configuration of the card reader 263 is the same as that of the card reader 13 (FIG. 1) of the first embodiment, except the function of an application 275 (FIG. 32) concerning the processes in FIGS. 34 to 37.

As illustrated in FIG. 33, the core banking host computer 261 of the third embodiment holds a host signature key 280, a host verification key 281, and a host verification key signature 282 in a data region 151B of a memory 151 in later-described various types of processing, instead of the host secret key 107, host public key 100, host public key signature 108, and CR verification key 97 in FIG. 6. In FIG. 33, the same portions as those in FIG. 6 are given the same reference numerals. The other configuration of the core banking host computer 261 is the same as the core banking host computer 3 (FIG. 1) of the first embodiment except the function of an application 283 (FIG. 33) concerning the processes in FIGS. 34 to 37.

The processes in FIGS. 34 to 37 that the CPU 170 of a certification authority 264 (FIG. 1) executes based on the application 172 stored in the memory 171 are partially different from those of the first embodiment. The other part of the processes is the same as that of the certificate authority 5 of the first embodiment.

### (3-2) Flow of Initial Setting of Root Key Pair and CR Key Pair

FIG. 34 illustrates the flow of the procedure to set initial keys (a root key pair and a CR key pair) that is executed in the automated transaction system 260 (FIG. 31) of the third embodiment, instead of FIG. 9.

For setting the initial keys, first, an asymmetric root key pair (the root signature key 109 and the root verification key 95) is generated in the certificate authority 264 having a secure environment by an organization (mainly assumed to be an ATM vender) responsible for secure transactions in the automated transaction system 260 (S270). The certificate authority 264 stores the generated root signature key 109 and root verification key 95 in the data region 171B of the memory 171 (FIG. 8) of the certificate authority 264 (S271).

In the ATM 262 (FIG. 31), the card reader cryptographic processor 270 (FIG. 32) of the card reader 263 (FIG. 31) generates an asymmetric CR key pair (the CR secret key 272 and the CR public key 273) (S272). The card reader cryptographic processor 270 then stores the generated CR secret key 272 and CR public key 273 in the data region 91B (FIG. 32) of the memory 91 (FIG. 32) (S273). Thereafter, the card reader cryptographic processor 270 transmits the CR public key 273 to the certificate authority 264 to give an electronic signature to the CR public key 273 using the root signature key 109 (S274).

Upon receiving the CR public key 273 (S275), the certificate authority 264 uses the root signature key 109 generated in the step S270 to give an electronic signature to the CR public key 273 (S276). The certificate authority 264 transmits a CR public key signature 274, which is the given electronic signature, and the root verification key 95 to the card reader cryptographic processor 270 (S277).

Upon receiving the CR public key signature 274 and root verification key 95 (S278), the card reader cryptographic processor 270 stores the received CR public key signature 274 and root verification key 95 in the data region 91B (FIG. 32) of the memory 91 (FIG. 32) (S279).

### (3-3) Flow of Initial Setting of Encryption Key (Host Key)

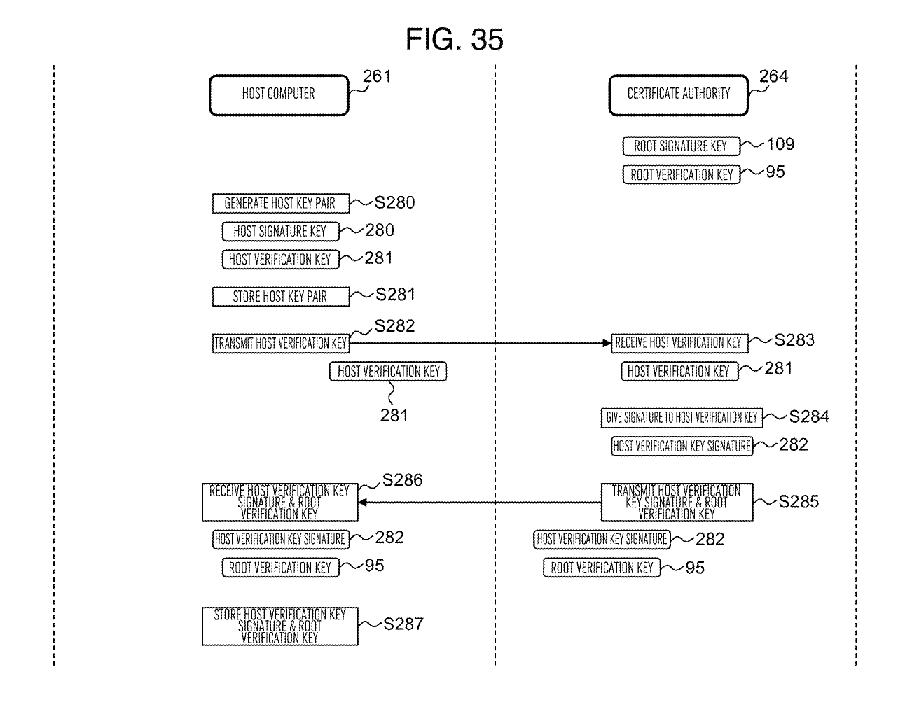

FIG. 35 illustrates the flow of the setting procedure for initial keys (host keys) that is executed in the automated transaction system 260 (FIG. 31) of the third embodiment, instead of FIG. 11.

After the certificate authority 264 generates the root signature key 109 and root verification key 95 described for FIG. 34, first, the core banking host computer 261 generates an asymmetric host key pair (the host signature key 280 and the host verification key 281) (S280). The core banking host computer 261 stores the generated host signature key 280 and host verification key 281 in the memory 151B (FIG. 33) of the memory 151 (FIG. 33) (S281).

The core banking host computer 261 transmits the host verification key 281 to the certificate authority 264 to give an electronic signature to the host verification key 281 using the root signature key 109 (S282).

Upon receiving the host verification key 281 (S283), the certificate authority 264 uses the root signature key 109 to give an electronic signature to the host verification key 281 (S284). The certificate authority 264 transmits a host verification key signature 282, which is the electronic signature given to the host verification key 281, and the root verification key 95 to the core banking host computer 261 (S285).

Upon receiving the host verification key signature 282 and root verification key 95 (S286), the core banking host computer 261 stores the host verification key signature 282 and root verification key 95 in the data region 151B (FIG. 33) of the memory 151 (FIG. 33) (S287).

### (3-4) Master Key Exchange (CR-Host)

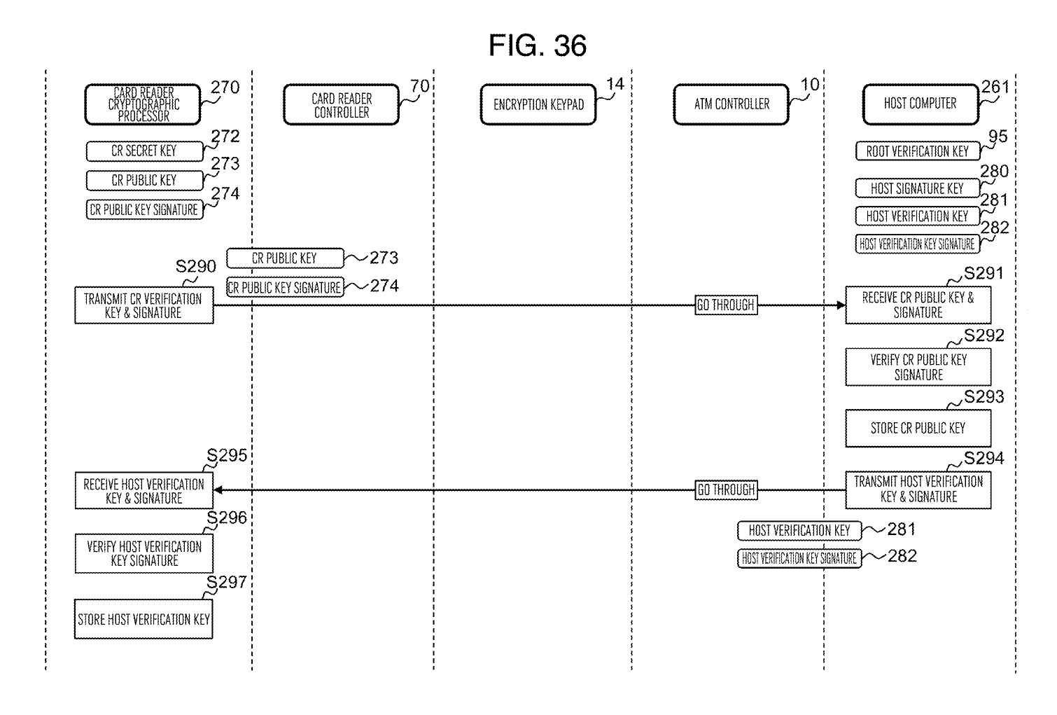

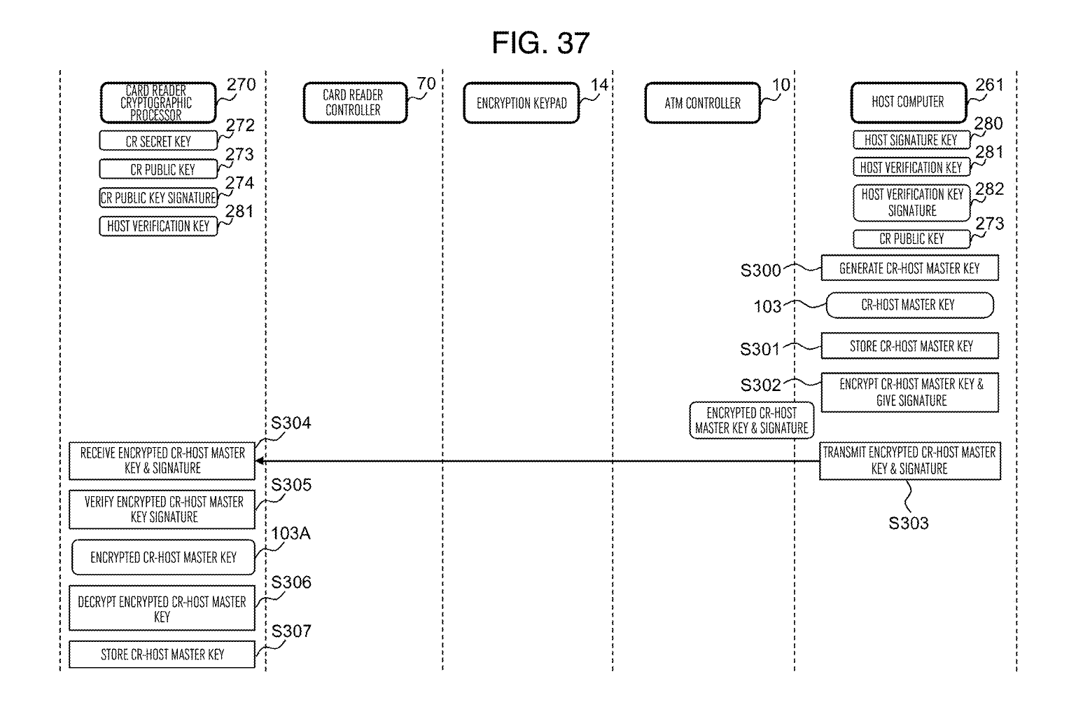

FIGS. 36 and 37 illustrate the flow of a process executed in the automated transaction system 260 (FIG. 31) of the third embodiment in order for the card reader 263 and the core banking host computer 261 to share the master key instead of FIGS. 14 and 15. In this case, the card reader cryptographic processor 270 first transmits the CR public key 273 and CR public key signature 274 to the core banking host computer 261 (S290).

Upon receiving the CR public key 273 and CR public key signature 274 (S291), the core banking host computer 261 verifies the signature validity of the CR public key signature 274 using the root verification key 95 (S292). When the signature validity is verified, the core banking host computer 261 stores the CR public key 273 in the data region 151B (FIG. 33) of the memory 151 (FIG. 33) (S293). The core banking host computer 261 then transmits the host verification key 281 and host verification key signature 282 to the card reader cryptographic processor 270 (S294).

Upon receiving the host verification key 281 and host verification key signature 282 (S295), the card reader cryptographic processor 270 verifies the signature validity of the host verification key signature 282 using the root verification key 95 (S296). When the signature validity is verified, the card reader cryptographic processor 270 stores the host verification key 281 in the data region 91B (FIG. 32) of the memory 91 (FIG. 32) (S297).

As illustrated in FIG. 37, the core banking host computer 261 generates the CR-host master key 103 using random numbers (S300) and stores the generated CR-host master key 103 in the data region 91B (FIG. 32) of the memory 91 (FIG. 32) (S301).

The core banking host computer 261 further encrypts the CR-host master key 103 using the CR public key 273 and gives an electronic signature to the encrypted CR-host master key 103 (hereinafter, referred to as an encrypted host master key 103A) using the host signature key 280 (S302). The core banking host computer 261 then transmits the encrypted CR-host master key 103A and electronic signature to the card reader cryptographic processor 270 (S303).

Upon receiving the encrypted CR-host master key 103A and electronic signature (S304), the card reader cryptographic processor 270 first verifies the validity of the electronic signature using the host verification key 281 (S305). When the validity of the electronic signature is verified, the card reader cryptographic processor 270 decrypts the encrypted CR-host master key 103A using the CR secret key 272 (S306) and stores the thus-obtained decrypted CR-host master key 103 in the data region 91B (FIG. 32) of the memory 91 (FIG. 32) (S307).

As for subsequent generation of session keys, in the first embodiment (FIG. 17), sharing of the CR-host session key is implemented in such a manner that the CR-host session key is generated by the card reader cryptographic processor 72 and transmitted to the core banking host computer 3. In the third embodiment, the CR-host session key is shared similarly to FIG. 17 in the following manner: the CR-host session key is generated and encrypted in the core banking host computer 261 and is transmitted to the card reader cryptographic processor 270. The encrypted CR-host session key is decrypted in the card reader cryptographic processor 270 and is stored in the memory 91.

### (3-5) Effect of Third Embodiment

As described above, according to the automated transaction system 260 of the third embodiment, in order for the card reader cryptographic processor 270 of the card reader 263 of the ATM 262 and the core banking host computer 261 to share the CR-host session key 104 used for encryption in communication therebetween, the CR-host master key 103 used to encrypt the CR-host session key 104 is generated in the core banking host computer 261. The CR-host master key 103 used between the core banking host computer 261 and each of the plurality of ATM 262 and can be therefore collectively managed in the core banking host computer 261.

Accordingly, the CR-host master key is easily managed compared with the case where the CR-host master key 103 is generated by the card reader cryptographic processor 72 (FIG. 3C) of the card reader 13 (FIG. 1) of each ATM 2(FIG 1) like the first embodiment. In addition, compared with the case where the CR-host master key 103 is managed at each ATM 262 as a terminal, risk of hacking can be reduced.

### (4) Other Embodiments

In the aforementioned first to third embodiments, the ATMs 2, 252, and 262, as the automated transaction apparatus, are configured as illustrated in FIGS. 1, 28, and 31, respectively. However, the present invention is not limited to those configurations and is applicable to a wide variety of configurations. Transactions at the ATMs 2, 252, and 262 include transactions performed after card authentication, such as deposits, withdrawals, transmissions, and balance confirmation.

In the aforementioned first to third embodiments, the card medium is the IC card 21. However, the present invention is not limited to such an IC card and is also applicable to the case where the card medium is a magnetic card.

In the aforementioned first to third embodiments, the ATM controllers 10 and 253 are respectively configured as illustrated in FIGS. 2 and 28 as the apparatus controller that executes the control process to generate the transaction request message 230 (FIG. 25), transmit the transaction request message 230 to the core banking host computer 3 (the host apparatus), and implement a transaction based on the transaction response message 243 (FIG. 26) from the core banking host computer 3. However, the present invention is not limited to those configurations and is applicable to a wide variety of configurations.

In the aforementioned first to third embodiments, the FIT 157 and FIT confidential information table 157A have a table form. However, the form thereof is not limited to a table form. The FIT 157 and FIT confidential information table 157A only need to be information relating information necessary to execute the aforementioned processes (information related to the format of card information of each financial constitution, for example).

In the aforementioned second embodiment, the FIT confidential information table 157A is generated for each financial institution by extracting the information 161, 162, 164, 165, and 167 (the financial institution ID offset, financial institution ID, PAN offset, PAN length, and language code) from the record information of the record 160A of the financial institution. The present invention is not limited to this configuration. The FIT confidential information table may include information other than the information 161, 162, 164, 165, and 167.

### INDUSTRIAL APPLICABILITY

The present invention is applicable to an automated transaction system which includes an ATM performing deposit and withdrawal transactions based on card information and a user's operation; and a core banking host computer performing authentication of the deposit and withdrawal transactions and the like.

### REFERENCE SIGNS LIST

1, 250, 260 . . . AUTOMATED TRANSACTION SYSTEM

2, 252, 262 . . . ATM

3, 251, 261 . . . CORE BANKING HOST COMPUTER

5, 264 . . . CERTIFICATE AUTHORITY

10, 253 . . . ATM CONTROLLER

13, 254, 263 . . . CARD READER

14 . . . ENCRYPTION KEYPAD

21 . . . IC CARD

30, 90, 120, 150, 170 . . . CPU

72 . . . CARD READER CRYPTOGRAPHIC PROCESSOR

110 . . . ENCRYPTION KEYPAD CONTROLLER

130 . . . IC REGION

140 . . . MAGNETIC REGION

157 . . . FIT

157A . . . FIT CONFIDENTIAL INFORMATION TABLE

1. An automated transaction system, comprising
an automated transaction apparatus; and
a host apparatus,
wherein a request message for a transaction corresponding to a user's operation to the automated transaction apparatus is transmitted from the automated transaction apparatus to the host apparatus and the automated transaction apparatus performs the transaction based on a response message from the host apparatus responsive to the request message,
wherein the automated transaction apparatus includes:
a card reader that reads first card information recorded in the card medium inserted by the user: and
an apparatus controller that generates and transmits to the host apparatus the request message, and executes a control process to perform the transaction based on the response message from the host apparatus,
wherein the card reader
holds first card format information which is specific to a respective financial institution and in which information that is related to a format of the first card information is registered,
acquires predetermined confidential information including the card number from the first card information read from the card medium, with reference to the first card format information, and
encrypts and transmits to the apparatus controller the acquired confidential information, and
wherein the apparatus controller generates and transmits to the host apparatus the request message including the encrypted confidential information transmitted from the card reader.

2. The automated transaction system according to claim 1, further comprising:
an encryption keypad including a keypad, the encryption keypad encrypting and transmitting to the apparatus controller a personal identification number entered by the user through the keypad,
wherein the card reader transmits the encrypted card number among the confidential information via the apparatus controller to the encryption keypad.

3. The automated transaction system according to claim 1,
wherein a part of the information related to the format of the first card information is registered in the first card format information,
wherein the part of the information related to the format of the first card information registered in the first card format information is information necessary to acquire the confidential information of the respective financial institution from the first card information,
wherein the card reader, while encrypting and transmitting to the apparatus controller the confidential information among the first card information read from the card medium, transmits second card information to the apparatus controller, the second card information being the first card information with the confidential information masked and rest of information not masked,
wherein the apparatus controller holds second card format information in which information related to a format of the card information of the respective financial institution is registered and acquires necessary information from the second card information, with reference to the second card format information.

4. The automated transaction system according to claim 1, wherein the host apparatus generates a master key to encrypt a session key that is used for encryption in communication between the host apparatus and the card reader of the automated transaction apparatus, and shares the generated master key with the card reader.

5. A control method of an automated transaction system which includes an automated transaction apparatus and a host apparatus and in which a request message for a transaction corresponding to a user's operation to the automated transaction apparatus is transmitted from the automated transaction apparatus to the host apparatus and the automated transaction apparatus performs the transaction based on a response message from the host apparatus responsive to the request message,
wherein the automated transaction apparatus includes:
a card reader that reads first card information recorded in the card medium inserted by the user; and
an apparatus controller that generates and transmits to the host apparatus the request message, and executes a control process to perform the transaction based on the response message from the host apparatus,
wherein the card reader holds first card format information which is specific to a respective financial institution and in which information that is related to a format of the first card information is registered, the control method comprising:
a first step of the card reader acquiring predetermined confidential information including the card number from the first card information read from the card medium, with reference to the first card format information;
a second step of the card reader encrypting and transmitting to the apparatus controller the acquired confidential information; and
a third step of the apparatus controller generating and transmitting to the host apparatus the request message including the encrypted confidential information transmitted from the card reader.

6. The control method of an automated transaction system according to claim 5, wherein the automated transaction system includes an encryption keypad including a keypad, the encryption keypad encrypting and transmitting to the apparatus controller a personal identification number entered by the user through the keypad, and
wherein the card reader transmits the encrypted card number among the confidential information via the apparatus controller to the encryption keypad in the second step.

7. The control method of an automated transaction system according to claim 5,
wherein a part of the information related to the format of the first card information is registered in the first card format information,
wherein the part of the information related to the format of the first card information registered in the first card format information is information necessary to acquire the confidential information of the respective financial institution from the first card information,
wherein the card reader, while encrypting and transmitting to the apparatus controller the confidential information among the first card information read from the card medium, transmits second card information to the apparatus controller in the second step, the second card information being the first card information with the confidential information masked and rest of information not masked,
wherein the apparatus controller holds second card format information which is specific to the respective financial institution and in which information related to a format of the card information is registered, and
wherein the apparatus controller acquires necessary information from the second card information in the third step, with reference to the second card format information.

8. The control method of an automated transaction system according to claim 5, wherein the host apparatus generates a master key to encrypt a session key that is used for encryption in communication between the host apparatus and a card reader of the automated transaction apparatus, and shares the generated master key with the card reader.

9. A card reader which is provided for an automated transaction apparatus that transmits a request message for a transaction corresponding to a user's operation and performs the transaction based on a response message from a host apparatus responsive to the request message, the card reader reading card information recorded in a card medium from the card medium inserted into the automated transaction apparatus by the user, the card reader comprising:
a card reading section which reads the card information from the card medium inserted into the automated transaction apparatus; and
a card reader cryptographic processor which encrypts the card information read from the card medium by the card reading section,
wherein the automated transaction apparatus includes an apparatus controller that generates and transmits to the host apparatus the request message, and executes a control process to perform the transaction based on the response message from the host apparatus, and
wherein the card reader cryptographic processor
holds first card format information which is specific to a respective financial institution and in which information that is related to a format of the first card information is registered,
acquires predetermined confidential information including the card number from the first card information read from the card medium, with reference to the first card format information, and
encrypts and transmits to the apparatus controller the acquired confidential information.
